(19) United States
(12) Patent Application Publication
(10) Pub. No.: US 2012/0066078 A1
(43) Pub. Date: Mar. 15, 2012

(54) OVERAGE SERVICE USING OVERAGE PASSCODE

(75) Inventors: Tamara S. Kingston, Peoria, AZ (US); Willard Andrew Barr, Charlotte, NC (US); Doris Maria Garrett, Walnut Creek, CA (US); Mark Allan Nelson, Waxhaw, NC (US); Jonathan H. Tucker, Charlotte, NC (US); John Franklin Tuders, Harrisburg, NC (US); Elbert Lee Whitler, Webster Groves, MO (US)

(73) Assignee: BANK OF AMERICA CORPORATION, Charlotte, NC (US)

(21) Appl. No.: 13/094,564

(22) Filed: Apr. 26, 2011

Related U.S. Application Data
(63) Continuation-in-part of application No. 12/879,866, filed on Sep. 10, 2010.
Application No. 12/879,866 is a continuation-in-part of application No. 13/033,492, filed on Feb. 23, 2011.
Application No. 13/033,492 is a continuation-in-part of application No. 13/033,501, filed on Feb. 23, 2011.
Application No. 13/033,501 is a continuation-in-part of application No. 13/033,510, filed on Feb. 23, 2011.
(60) Provisional application No. 61/416,652, filed on Nov. 23, 2010.
(60) Provisional application No. 61/436,196, filed on Jan. 26, 2011.

(51) Int. Cl. G06Q 40/00

(52) U.S. Cl. 705/16; 705/44

(57) ABSTRACT

In general terms, embodiments of the present invention relate to methods and apparatuses for providing an overage service using an overage passcode. For example, in some embodiments, a method is provided that includes: (a) receiving transaction information associated with a transaction, where the transaction involves an account; (b) determining, based at least partially on the transaction information, that the account will incur an overage as a result of the transaction; (c) receiving an overage passcode associated with the account; and (d) authorizing the transaction based at least partially on the receiving the overage passcode.

### CROSS-REFERENCE TO RELATED APPLICATIONS

The present application is a continuation-in-part application of, and claims priority to, U.S. patent application Ser. No. 12/879,866, which was filed on Sep. 10, 2010, and is entitled “Service Participation Acknowledgment System,” and which is incorporated by reference herein in its entirety. The present application also claims priority to U.S. Provisional Patent Application No. 61/416,652, which was filed on Nov. 23, 2010, and is entitled “Overage Communication Systems,” and which is incorporated by reference herein in its entirety. The present application further claims priority to U.S. Provisional Patent Application No. 61/436,196, which was filed on Jan. 26, 2011, and is entitled “Overage Communication Systems,” and which is incorporated by reference herein in its entirety. The present application is also a continuation-in-part application of, and claims priority to, U.S. patent application Ser. No. 13/033,492, which was filed on Feb. 23, 2011, and is entitled “Overage Service via Mobile Device,” and which is incorporated by reference herein in its entirety. The present application is also a continuation-in-part application of, and claims priority to, U.S. patent application Ser. No. 13/033,501, which was filed on Feb. 23, 2011, and is entitled “Overage Service via Transaction Machine,” and which is incorporated by reference herein in its entirety. The present application is also a continuation-in-part application of, and claims priority to, U.S. patent application Ser. No. 13/033,510, which was filed on Feb. 23, 2011, and is entitled “Overage Service Subject to Condition,” and which is incorporated by reference herein in its entirety.

### BACKGROUND

Financial institution customers are constantly looking for new and useful ways to better manage their finances. This is particularly so given that most of today's customers have multiple financial accounts and the consequences associated with mismanaging or forgetting about any one of them can lead to unexpected and/or unwanted outcomes. For example, a customer may overdraft his checking account and incur a related overdraft fee by engaging in a transaction that he mistakenly believes his account can cover. Accordingly, there is a need to provide methods and apparatuses that help financial institution customers manage their finances in ways that avoid or reduce unexpected or unwanted outcomes.

### SUMMARY OF SELECTED EMBODIMENTS OF THE PRESENT INVENTION

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

In general terms, embodiments of the present invention relate to methods and apparatuses for providing an overage service using an overage passcode (e.g., personal identification number (PIN), password, numeric code, etc.). As a specific example, in some embodiments, a method involves: (a) a financial institution customer using a primary PIN (e.g., “3441”) associated with the customer's checking account to engage in a transaction at a point-of-sale (POS) device (e.g., at a merchant); (b) a financial institution apparatus determining that the checking account will incur an overdraft as a result of the transaction (e.g., the checking account does not have sufficient funds to cover the transaction); (c) the apparatus declining the overdraft transaction as a result of making the overdraft determination; (d) the customer inputting an overdraft PIN (e.g., “5789”) associated with the checking account into a keypad of the POS device in order to indicate that the customer consents to the overdraft and/or to completing the overdraft transaction; and (e) the apparatus authorizing and/or completing the transaction based at least partially on the apparatus receiving the overdraft PIN from the customer via the POS device.

In this example, by using the overdraft PIN, the customer is empowered to decide whether he wants to incur the overdraft, complete the transaction, incur an overdraft fee for overdrafting his checking account and/or for using the overdraft service, etc., which reduces or eliminates the possibility that the customer will unknowingly or unexpectedly engage in an overdraft transaction (and/or unknowingly or unexpectedly incur an overdraft fee). In addition, because the customer inputs the overdraft PIN during the transaction (e.g., after the transaction is initiated but before the transaction is authorized and/or completed), the customer is able to make this decision in real-time and/or on a per-transaction basis. Further, in this example embodiment, the customer may input his overdraft PIN into the POS device discreetly, thereby avoiding any potential embarrassment associated with incurring the overdraft and/or using the overdraft service.

In more general terms, some embodiments of the present invention provide a method that includes: (a) receiving transaction information associated with a transaction, where the transaction involves an account; (b) determining, based at least partially on the transaction information, that the account will incur an overage as a result of the transaction; (c) receiving an overage passcode associated with the account; and (d) authorizing the transaction based at least partially on the receiving the overage passcode.

Other embodiments of the present invention provide an apparatus that includes: (a) a communication interface configured to: (i) receive, via a payment network, transaction information associated with a transaction, where the transaction involves an account; and (ii) receive an overage passcode associated with the account; and (b) a processor operatively connected to the communication interface and configured to: (i) determine, based at least partially on the transaction information, that the account will incur an overage as a result of the transaction; and (ii) authorize the transaction based at least partially on the communication interface receiving the overage passcode.

Still other embodiments provide a computer program product having a non-transitory computer-readable medium, where the non-transitory computer-readable medium includes one or more computer-executable program code portions that, when executed by a computer, cause the computer to: (a) receive transaction information associated with a transaction, where the transaction involves an account; (b) determine that the account will incur an overage as a result of the transaction; (c) receive an overage passcode associated with the account after the computer determines that account will incur an overage; and (d) authorize the transaction based at least partially on the computer receiving the overage passcode.

Other embodiments of the present invention provide a method that includes: (a) receiving an authorization request associated with a transaction, where the transaction involves an account, and where the account is associated with a primary passcode; (b) determining that the account does not have sufficient funds or credit to cover the transaction; (c) determining that the authorization request includes the primary passcode; (d) declining the authorization request based at least partially on the determining that the authorization request includes the primary passcode and the determining that the account does not have sufficient funds or credit; (e) receiving a second authorization request associated with a second transaction, where the second transaction involves the account; (f) determining that the second authorization request includes an overage passcode associated with the account; and (g) approving the second authorization request based at least partially on the determining that the second authorization request includes the overage passcode.

Still other embodiments of the present invention provide a method that includes: (a) presenting, by a holder of an account, account information at a transaction machine to engage in a transaction, where the account information is associated with the account; (b) receiving, by the holder, a message that prompts the holder to provide an overage passcode associated with the account, where the receiving occurs while the holder is still at the transaction machine; and (c) inputting, by the holder, the overage passcode into the transaction machine or into a mobile device accessible to a holder, where the inputting occurs while the holder is still at the transaction machine, and where the transaction is approved after the holder inputs the overage passcode.

### BRIEF DESCRIPTION OF THE DRAWINGS

Having thus described some embodiments of the present invention in general terms, reference will now be made to the accompanying drawings, where:

FIG. 1 is a flow diagram illustrating a general process flow for providing an overage service using an overage passcode, in accordance with an embodiment of the present invention;

FIG. 2 is a flow diagram illustrating a more-detailed process flow for providing an overage service using a overage PIN, in accordance with an embodiment of the present invention;

FIG. 3 is a block diagram illustrating technical components of a system for providing an overage service, in accordance with an embodiment of the present invention;

FIG. 3A is a block diagram illustrating technical components of a mobile device configured to participate in an overage service, in accordance with an embodiment of the present invention;

FIG. 4 is a mixed block and flow diagram of a system for providing an overdraft service using an overdraft PIN and a mobile phone, in accordance with an embodiment of the present invention; and

FIG. 5 is a mixed block and flow diagram of a system for providing an over limit service using an over limit password and a mobile phone having a near field communication (NFC) interface, in accordance with an embodiment of the present invention.

### DETAILED DESCRIPTION OF EMBODIMENTS OF THE PRESENT INVENTION

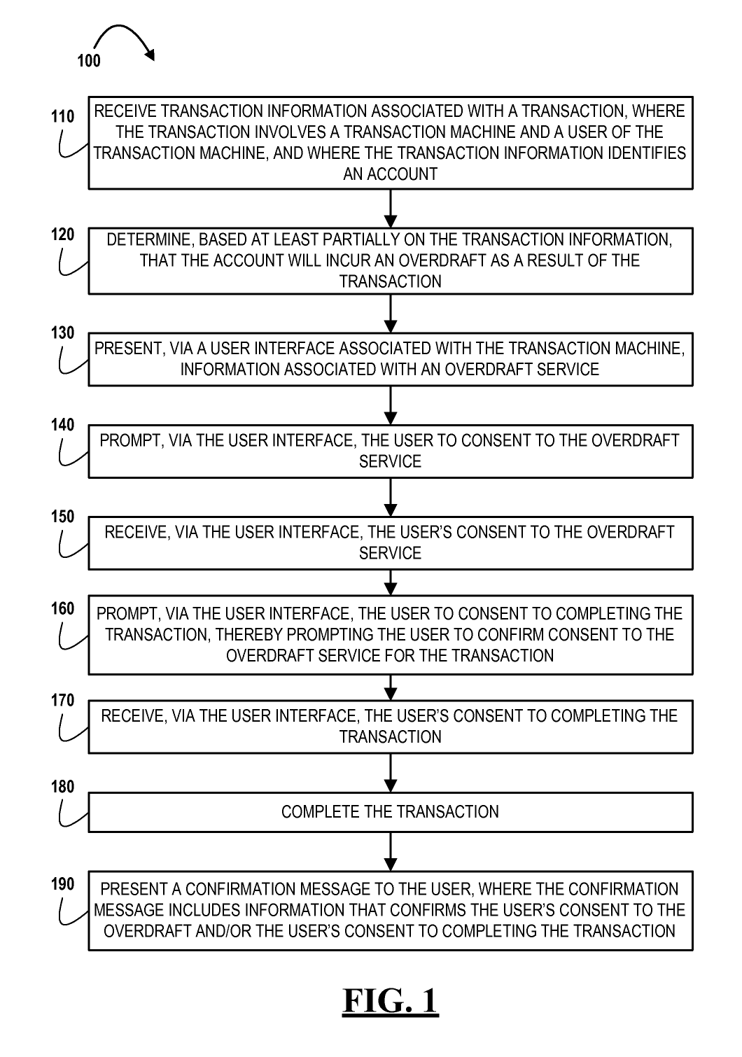

Referring now to FIG. 1, a general process flow 100 for providing an overage service using an overage passcode is provided, in accordance with an embodiment of the present invention. In some embodiments, the process flow 100 is performed by an apparatus (i.e., one or more apparatuses) having hardware and/or software configured to perform one or more portions of the process flow 100. In such embodiments, as represented by block 110, the apparatus is configured to receive transaction information associated with a transaction, where the transaction involves an account (e.g., a deposit account, a credit account, etc.), a transaction machine (e.g., a POS device, an automated teller machine (ATM), etc.), and a holder of the account (and/or the user of the transaction machine), and where the account is associated with a primary passcode (e.g., “1248,” “panthers”). As represented by block 120, the apparatus is also configured to determine, based at least partially on the transaction information, that the account will incur an overage (e.g., incur an overdraft, go over a credit limit, etc.) as a result of the transaction. In addition, as represented by block 130, the apparatus is further configured to receive an overage passcode (e.g., “4518,” “overage123,” etc.) associated with the account. As represented by block 140, the apparatus is further configured to authorize the transaction based at least partially on the apparatus receiving the overage passcode.

For simplicity, it will be understood that the portion of the process flow represented by block 120 is sometimes referred to herein as the “overage determination.” Also, the phrase “overage transaction” is sometimes used to refer to a transaction that, if completed, would cause the account to incur an overage (e.g., incur an overdraft, go over a credit limit, etc.). In addition, it will be understood that, in some embodiments, the term “determine” is meant to have one or more of its ordinary meanings (i.e., its ordinary dictionary definition(s)), but that in other embodiments, that term is meant to have one or more ordinary meanings of one or more of the following terms: decide, conclude, verify, ascertain, find, discover, learn, calculate, observe, read, and/or the like. Further, in some embodiments, the phrase “based at least partially on” is meant to have one or more of its ordinary meanings, but that in other embodiments, that phrase is meant to have one or more ordinary meanings of one or more of the following terms and/or phrases: as a result of, because of, after, if, when, in response to, and/or the like. Still further, in some embodiments, the term “via” is meant to have its one or more ordinary meanings, but in other embodiments, that term is meant to have one or more ordinary meanings of one or more of the following terms and/or phrases: from, through, per, with the assistance of, by way of, and/or the like.

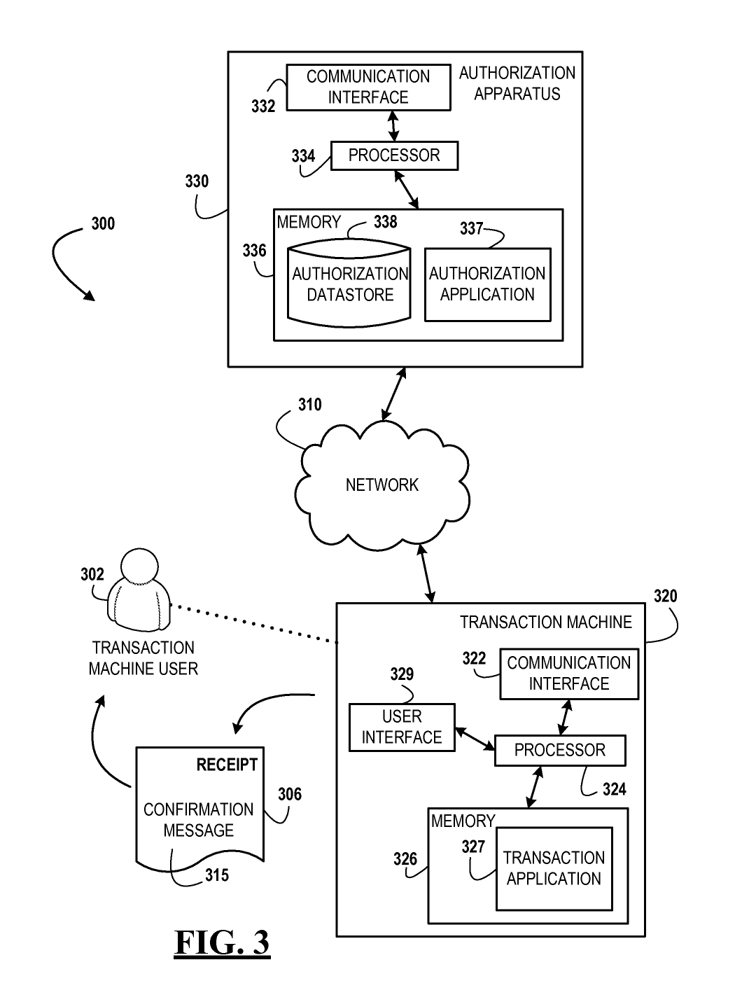

It will also be understood that the apparatus having the process flow 100 can include one or more separate and/or different apparatuses. For example, in some embodiments, one apparatus (e.g., the transaction machine 320 described in connection with FIG. 3, etc.) is configured to perform the portion of the process flow 100 represented by block 110, and a second apparatus (e.g., the authorization apparatus 330) is configured to perform the portions represented by blocks 120-140. As still another example, in some embodiments, a single apparatus (e.g., the authorization apparatus 330) is configured to perform each and every portion of the process flow 100. It will also be understood that, in some embodiments, a transaction machine (e.g., the transaction machine 320) is configured to perform one or more (or all) of the portions of the process flow 100, and that in some embodiments, that transaction machine includes, is included in, and/or is embodied as the transaction machine referred to in block 110.

Regarding block 110, the term “passcode,” as used herein, generally refers to a personal identification number (PIN), code, string, keyword, number, phrase, password, username, personal identifier, and/or the like that the holder uses to access banking services and/or to engage in transactions. Indeed, in some embodiments, the passcode is required to access those banking services and/or to engage in those transactions. For example, in some embodiments, the passcode must be input into the transaction machine referred to in the process flow 100 before the transaction machine will perform the transaction. Also, it will be understood that the passcode may be of any length and include any type of character. For example, in some embodiments, the passcode is a four or six digit PIN (e.g., “3451,” “8911,” “566912,” etc.) that the holder must input into an ATM to withdraw funds and/or into a POS device to complete a purchase transaction. Of course, it will be understood that, in other embodiments, the passcode is a different length and/or includes one or more letters and/or symbols in addition to, or instead of, numbers.

Also, it will be understood that, in some embodiments, the passcode is secret and/or confidential, such that, for example, the passcode is known only to the holder and the holder's financial institution. Additionally or alternatively, in some embodiments, the financial institution that maintains the account associates the passcode with the holder, the account, and/or the debit and/or credit card associated with the account. Of course, because a financial institution may maintain millions of accounts, a particular passcode associated with one account may actually be the same passcode associated with another account. In such cases, the identity of the passcode cannot be used by itself to actually identify a holder of an account. However, in some embodiments of the present invention, the passcode is uniquely associated with the holder, the account, and/or a debit and/or card associated with the account, such that, for example, the holder, the account, and/or the card may be identified simply by knowing the identity of the passcode (and/or vice versa). Additionally or alternatively, in some embodiments, where the passcode is secret and/or confidential, the passcode may be used to authenticate the holder (e.g., verify that the holder is who he says he is) to the apparatus having the process flow 100, to the financial institution that maintains the account, and/or to a merchant and/or counterparty involved in the transaction.

It will be understood that a passcode may be different than a card verification value (CVV). As understood herein, a CVV is typically a three or four digit number that is printed on a debit and/or credit card, and that may be used, for example, during web or phone transactions, to verify that the card holder actually possesses the debit and/or credit card at the time of the transaction. In contrast, a passcode is not typically printed on a debit and/or credit card associated with the account. Further, because the CVV is typically printed on a card, anyone with access to that card may view the CVV. Thus, in embodiments where the passcode is known only to the holder of the account and to the financial institution that maintains the account, the identity of the passcode is typically a secret more closely guarded than the identity of the CVV.

Additionally, it will be understood that there are two kinds of passcodes referred to herein, a primary passcode and an overage passcode. It will be understood that the primary passcode refers to a passcode typically used to engage in regular, day-to-day transactions and typically associated with the holder, the account, and/or the debit and/or credit card involved in those transactions. The overage passcode also refers to a passcode that is associated with the holder, account, and/or debit and/or credit card involved in a transaction, but the overage passcode is typically used to engage in an overage transaction as opposed to a regular transaction. In some embodiments, the holder uses the overage passcode to “consent to the overage,” which is a phrase meant to be understood in its broadest sense. For example, in some embodiments, the phrase “consent to the overage” means consent to: (a) incurring the overage (e.g., the account and/or the holder incurring the overage, etc.); (b) incurring an overage fee associated with the overage (e.g., now or at the end of the day in which the transaction occurred if the account settles negative, etc.); (c) one or more terms of an overage service; (d) using the overage service for this transaction (i.e., the transaction referred to in block 110); (e) incurring an overage fee associated with using the overage service; and/or (f) completing the transaction. Thus, for example, the holder may provide the overage passcode to the apparatus having the process flow 100 to indicate that the holder consents to: (a) incurring overage; (b) incurring an overage fee associated with the overage; and (c) completing the transaction. Further, it will be understood that any given holder, account, and/or debit and/or credit card may be associated with a primary passcode and an overage passcode. Also, it will be understood that the primary passcode is typically different than the associated overage passcode. For example, in some embodiments, the primary passcode associated with the account is the four digit PIN “0786,” whereas the overage passcode associated with that account is the four digit PIN “1386.” Further, as understood herein, the overage passcode is sometimes referred to as an “over limit passcode” when associated with a credit account and referred to as an “overdraft passcode” when associated with a deposit account.

Also, in some embodiments, the primary passcode and/or the overage passcode referred to in the process flow 100 may be selected by the holder of the account before the transaction referred to in the process flow 100 is initiated (e.g., when the holder enrolls in an overage service). However, in other embodiments, the overage passcode is provided to the holder for the first time during the transaction referred to in the process flow 100 (e.g., via a message sent to the transaction machine or the holder's mobile device), such that the holder does not know the identity of the overage passcode before the transaction is initiated. In some of these embodiments, the overage passcode is dynamically generated, generated in real-time during the transaction, and/or automatically generated after the apparatus makes the overage determination but before the apparatus authorizes the transaction. This concept of generating and/or providing the overage passcode during the transaction is discussed in more detail later herein.

Still regarding block 110, the phrase “transaction machine,” as used herein, typically refers to an interactive computer terminal that is configured to initiate, perform, complete, and/or facilitate one or more financial transactions. Examples of transaction machines include, but are not limited to, ATMs, POS devices (e.g., merchant terminals, etc.), self-service machines (e.g., vending machine, self-checkout machine, parking meter, etc.), public and/or business kiosks (e.g., an Internet kiosk, ticketing kiosk, bill pay kiosk, etc.), mobile phones (e.g., feature phone, smart phone, iPhone®, etc.), gaming devices (e.g., Nintendo WHO, PlayStation Portable®, etc.), computers (e.g., personal computers, tablet computers, laptop computers, etc.), personal digital assistants (PDAs), and/or the like.

In some embodiments, the transaction machine referred to in block 110 is located in a public place and is available for public use (e.g., on a street corner, on the exterior wall of a banking center, at a public rest stop, etc.). In other embodiments, the transaction machine is additionally or alternatively located in a place of business and available for public and/or business customer use (e.g., in a retail store, post office, banking center, grocery store, etc.). In accordance with some embodiments, the transaction machine is not owned by the user of the transaction machine and/or the holder of the account referred to in block 110. However, in other embodiments, the transaction machine is located in a private place, is available for private use, and/or is owned by the user of the transaction machine and/or the holder referred to in block 110.

Further regarding block 110, the transaction involving the holder and the transaction machine can include any number and/or type of transaction(s) involving a transaction machine. For example, in some embodiments, the transaction includes one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards; donating to charities; and/or the like.

Also, the account referred to in the process flow 100 can include any number and/or type of account(s). For example, in some embodiments, the account includes a checking account, savings account, money market account, investment account, brokerage account, certificate of deposit account, and/or any other type of deposit account. In some embodiments, the deposit account is one or more accounts that can incur an overdraft and/or be overdrawn. Of course, it will be understood that embodiments of the present invention may also apply to one or more credit accounts, such as a credit card account, line of credit (LOC) account, store credit account, and/or the like. Additionally or alternatively, in some embodiments, the credit account is one or more accounts that can incur an amount “over limit.”

In some embodiments, the account, the transaction machine, and the apparatus having the process flow 100 are each controlled, serviced, owned, managed, operated, and/or maintained (collectively referred to herein as “maintained” for simplicity) by a single financial institution. For example, in some embodiments, the apparatus is maintained by a bank, the account is maintained by the bank, the transaction machine is owned by the bank, and the holder is a customer of the bank. Of course, it will be understood that, in some embodiments, the apparatus, the transaction machine, and/or the account are not maintained by the same financial institution (or any financial institution).

The transaction information referred to in block 110 can be any information that identifies, defines, describes, and/or is otherwise associated with the transaction. Exemplary transaction information includes, but is not limited to, the party(ies) involved in the transaction, the date and/or time of the transaction, the posting date of the transaction, the account(s) involved in the transaction, the primary passcode associated with the account, the overage passcode associated with the account, the transaction amount(s) associated with the transaction, the good(s) and/or service(s) involved in the transaction (e.g., product names, stock keeping unit (SKU) information, universal product code (UPC) information, etc.), a description of the transaction (which, itself, can include any transaction information, e.g., the description may describe the transaction status, the goods and/or services involved in the transaction, etc.), and/or the like.

The transaction information can also include any information that defines and/or identifies the type of the transaction. As understood herein, the transaction type of a transaction may be defined, at least in part, by the one or more goods and/or services involved in the transaction, the one or more types of accounts involved in the transaction (e.g., credit card transaction, savings account transaction, etc.), the one or more parties involved in the transaction (e.g., account holder, bank, teller, merchant, counterparty, etc.), when the transaction was initiated (e.g., time of day, day of week, etc.), and/or the like. In some embodiments, the transaction type is defined, at least in part, by the one or more channels through which the transaction is conducted, such as, for example, a POS device (e.g., merchant terminal, etc.), ATM, teller terminal, electronic banking account (e.g., online banking account, mobile banking account, SMS banking account, etc.), personal computer, kiosk, call center, and/or the like. Additionally or alternatively, in some embodiments, the transaction type is defined, at least in part, by the one or more instruments and/or methods used to conduct the transaction, such as, for example, paper checks, electronic checks, debit cards, credit cards, ATM cards, checkcards, wire transfers, online bill pay, automated clearing house (ACH), contactless payments, near field communication (NFC) interface payments, cash payments, and/or the like.

In some embodiments, the transaction information additionally or alternatively identifies and/or describes one or more merchant category codes (MCCs) associated with the transaction. As used herein, the phrase “merchant category code” generally refers to a number assigned to a merchant by a financial institution, where the number is used to classify the merchant by the type of goods and/or services the merchant provides. In some embodiments, the merchant category code is a four digit number assigned by VISA®, MasterCard®, and/or some other credit card provider (which, in some embodiments, is a bank). Exemplary merchant category codes include “5814” for fast food restaurants, “5933” for pawn shops, “8062” for hospitals, “5411” for grocery supermarkets, and “3501” for Holiday Inn Express®. A merchant category code may generally refer to the goods and/or services provided by a merchant (e.g., hospital, fast food restaurant, etc.) and/or may specifically identify the name of an individual merchant (e.g., Holiday Inn Express®, Mirage Hotel & Casino®, etc.). In other words, individual industries and/or individual merchants can have their own merchant category codes. In some embodiments, a transaction type may be defined, at least in part, by one or more merchant category codes associated with the transaction.

It will be understood that any given transaction may have more than one transaction type. For example, in accordance with some embodiments, a cash withdrawal transaction conducted an ATM may be defined as a cash-related transaction, a withdrawal transaction, and/or an ATM transaction. As another example, in accordance with some embodiments, a purchase transaction involving a POS device and a mobile device, where each of the POS device and the mobile device has an NFC interface, may be defined as a purchase transaction, a POS device transaction, mobile device transaction, an NFC interface transaction, and/or a contactless payment transaction. As still another example, in accordance with some embodiments, a purchase transaction involving a POS device maintained by a grocery store may be defined as a purchase transaction, a POS device transaction, a grocery store transaction, and/or a merchant category code “5411” transaction.

Also regarding block 110, the apparatus having the process flow 100 can be configured to receive the transaction information in any way. For example, in some embodiments, the apparatus is configured to receive an authorization request associated with the transaction, where the authorization request includes the transaction information. In some embodiments, the apparatus is embodied as an authorization apparatus maintained by a financial institution, where the apparatus is configured to consider, approve, and/or decline authorization requests for debit transactions, credit transactions, ATM transactions, POS device transactions, and/or one or more other types of transactions that involve one or more accounts maintained by the financial institution.

In some embodiments, the apparatus having the process flow 100 is configured to receive the transaction information based at least partially on the holder presenting account information (e.g., account number, debit card number, credit card number, credentials, passcode (e.g., primary passcode, overage passcode), expiration date of debit card or credit card, name(s) of holder(s) of the account, etc.) at the transaction machine. For example, in some embodiments, the holder presents account information at the transaction machine by swiping a debit card or credit card through the POS device. As another example, in some embodiments, the holder presents account information at the transaction machine by inputting account information into the transaction machine via a user interface associated with the transaction machine. As still another example, in some embodiments, the holder presents account information at the transaction machine by “tapping” an NFC-enabled mobile device at an NFC-enabled transaction machine (e.g., holding the NFC interface of the mobile device within approximately four inches of the NFC interface of the transaction machine, etc.) in order to communicate the account information from the mobile device to the transaction machine.

Additionally or alternatively, the apparatus can be configured to receive the transaction information directly or indirectly from the source of the transaction. For example, in some embodiments, the apparatus is located remotely from the transaction machine but is operatively connected to the transaction machine via a network. As another example, the apparatus may include, be included in, and/or be embodied as a transaction machine. For example, in some embodiments, the apparatus having the process flow 100 includes the transaction machine referred to in block 110. As another example, in some embodiments, the apparatus having the process flow 100 is embodied as the mobile device referred to in block 130. As still another example, in some embodiments, the apparatus having the process flow 100 is embodied as a transaction machine separate from, and/or different than, the transaction machine and/or mobile device mentioned in the process flow 100.

Regarding block 120, the term “overage,” as used herein, generally refers to the difference between: (a) the total amount of one or more purchases, draws, fees, charges, balance transfers, debt obligations, and/or other liabilities incurred, or that will be incurred, by an account as a result of a transaction, and (b) the amount of funds and/or credit available to the account immediately prior to the transaction. In some embodiments, the overage is referred to as an “overdraft” if the account that incurs the overage, or will incur the overage, is a deposit account. For example, if a checking account has an available balance of $25 immediately before the checking account is used to pay a $50 electric bill, then the checking account will incur a $25 overdraft as a result of paying the bill. In some embodiments, the term “overdraft” refers to the amount by which the balance of an account is negative. For example, if a deposit account has an available balance of −$65, then the deposit account has one or more overdrafts totaling $65. Additionally or alternatively, in some embodiments, the term “overdraft” refers to a situation where a deposit account is found to have insufficient funds (NSF) to cover a transaction.

In some embodiments, the overage is referred to as “going over limit” and/or “incurring an over limit amount” if the account that incurs the overage or will incur the overage is a credit account. For example, if a credit account has $500 in available credit immediately prior to the credit account being used to make a $600 purchase, then it will be understood that the credit account will go over its credit limit by $100 as a result of the purchase. Additionally or alternatively, in some embodiments, the phrase “over limit amount” generally refers to the difference between an account balance for the credit account and a credit limit (sometimes referred to as “credit line”) associated with the credit account. For example, if a credit account has a $5,000 credit limit and a $5,300 account balance, then it will be understood that the credit account has incurred one or more over limit amounts totaling $300.

Further regarding block 120, the apparatus configured to perform the process flow 100 can be configured to make the overage determination after the transaction has been initiated and/or before the transaction is authorized and/or completed (e.g., while the transaction is pending). In addition, the apparatus can be configured to make the overage determination in any way. For example, in some embodiments, the apparatus is configured to make the overage determination by determining that the account does not have sufficient available funds and/or credit to cover the transaction. In some embodiments, the apparatus having the process flow 100 includes and/or is embodied as a financial transaction processing apparatus that is configured to process financial transactions involving the account and/or the transaction machine referred to in block 110. In some of these embodiments, the apparatus is configured to make overage determinations for the account at the same time as, and/or nearly the same time as, the apparatus is processing transactions involving the account.

Additionally or alternatively, in some embodiments, the apparatus includes and/or is embodied as an authorization apparatus (e.g., the authorization apparatus 330 referred to in FIG. 3, etc.) that is configured to consider, authorize, and/or decline authorization requests and/or financial transactions. The apparatus configured to perform the process flow 100 can be configured to make overage determinations in real time and/or in substantially real time. In some embodiments, the apparatus is configured to determine the overage immediately or nearly immediately after the overage transaction has been initiated at the transaction machine (e.g., upon the swipe of a debit or credit card through a POS device, upon the holder selecting an amount to withdraw from an ATM, etc.). However, the apparatus having the process flow 100 can be configured to make the overage determination at any time from when the holder approaches the transaction machine to when the holder leaves the transaction machine. Additionally or alternatively, the apparatus can be configured to make the overage determination at any time from when the holder initiates and/or engages in the transaction at the transaction machine to when the transaction is completed.

Regarding block 130, in some embodiments, the transaction information referred to in block 110 includes the overage passcode, such that the apparatus having the process flow 100 receives the overage passcode by receiving the transaction information. For example, in some embodiments, the holder inputs the overage passcode into the transaction machine at and/or near the beginning of the transaction, such that the apparatus receives the overage passcode in the transaction information and/or before the apparatus makes the overage determination. In such embodiments, the holder does this so that the transaction will not be declined for insufficient funds and/or so that the holder will not need to input the overage passcode later (e.g., after the transaction has been declined). However, in other embodiments, the transaction information includes the primary passcode, and the apparatus receives the overage passcode after receiving the transaction information (and therefore after receiving the primary passcode). For example, in some embodiments, (a) the holder inputs the primary passcode into the transaction machine at and/or near the beginning of the transaction, such that the apparatus receives the primary passcode in the transaction information and/or before the apparatus makes the overage determination, (b) the apparatus declines the transaction as a result of making the overage determination and/or receiving the primary passcode in the transaction information, (c) the holder inputs the overage passcode into the transaction machine after the transaction has been declined, and (d) the apparatus authorizes the transaction as a result of receiving the overage passcode.

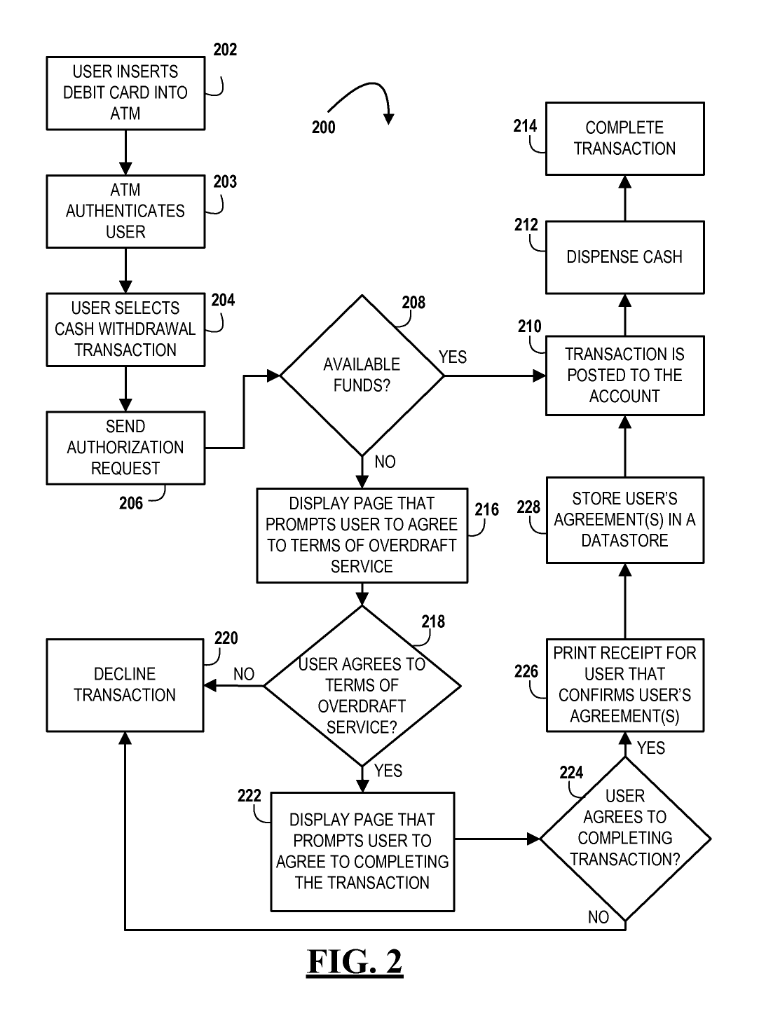

In some alternative embodiments (e.g., the embodiment described in connection with FIG. 2), the apparatus having the process flow 100 is configured to prompt the holder (e.g., via the transaction machine, via a mobile device accessible to the holder during the transaction, etc.) to provide the overage passcode to the apparatus having the process flow 100, where the prompting occurs after the apparatus determines that the account will incur the overage. In some of these embodiments, the apparatus receives the overage passcode based at least partially on (e.g., after, in response to, etc.) the apparatus prompting the holder. Further, in some embodiments, the apparatus is configured to prompt the holder within about twenty seconds of making the overage determination.

Further, in some alternative embodiments, the apparatus having the process flow 100 is configured to decline the transaction after making the overage determination. In some of these embodiments, the apparatus declining the transaction prompts the holder to provide the overage passcode to the apparatus, such that the apparatus receives the overage passcode after making the overage determination and/or after declining the transaction.

In some embodiments, the apparatus having the process flow 100 receives the overage passcode based at least partially on the holder inputting the overage passcode into the transaction machine referred to in block 110. Additionally or alternatively, in other embodiments, the apparatus receives the overage passcode based at least partially on the holder inputting the overage passcode into a mobile device accessible to the holder. In some of these embodiments, the holder carries, owns, controls, wears, and/or possesses the mobile device during the transaction (e.g., at some time after the transaction has been initiated but before the transaction is authorized and/or completed). It will be understood that, in some embodiments, by providing the overage passcode to the apparatus having the process flow 100, the holder consents to the overage (e.g., consents to incurring the overage, incurring an overage fee associated with the overage, one or more terms of an overage service, completing the transaction, etc.).

Regarding block 140, the apparatus is further configured to authorize the transaction based at least partially on the apparatus receiving the overage passcode. It will be understood that the apparatus can be configured to authorize the transaction in any way. For example, in some embodiments, the apparatus is configured to authorize the transaction by sending, to the transaction machine, one or more instructions to complete (and/or for completing) the transaction. In some embodiments, the apparatus is configured to authorize the transaction by approving an authorization request associated with the transaction. In some embodiments, the authorization request approved by the apparatus having the process flow 100 was included in the transaction information referred to in block 110. In some embodiments where the transaction machine referred to in block 110 is the apparatus having the process flow 100, the transaction machine authorizes and/or completes the transaction in response to receiving the holder's consent. In such embodiments, the transaction machine completes the transaction by performing one or more meaningful actions relevant to the transaction, such as, for example, dispensing cash, accepting a purchase transaction, accepting a check deposit, printing a receipt and/or statement, loading a prepaid storage card, transferring funds, and/or the like. In some embodiments, these one or more actions constitute the exchange central to the transaction, define the transaction, are desired by the holder to be performed, and/or were the reason the holder arrived at the transaction machine in the first place. Also, in some embodiments, the apparatus having the process flow 100 is configured to authorize the transaction by providing funds and/or credit sufficient to complete the transaction (e.g., to the account, to a merchant involved in the transaction, etc.).

Further, in some embodiments, the apparatus having the process flow 100 is configured to store the overage passcode a memory device (e.g., in an account profile associated with the account) before the transaction referred to in the process flow 100 is initiated. In such embodiments, the apparatus is also configured to, after receiving the overage passcode, determine the overage passcode received matches the overage passcode stored in the memory device. In some of these embodiments, the apparatus is configured to authorize the transaction based at least partially on the apparatus determining that the overage passcode received matches the overage passcode stored in the memory device.

In accordance with some embodiments, the apparatus configured to perform the process flow 100 is configured to perform the portions of the process flow 100 represented by blocks 110-140 at some point after the holder approaches the transaction machine for the transaction and before the holder leaves the transaction machine. In some embodiments, this means that the apparatus is configured to perform the one or more portions of the process flow 100 (e.g., make the overage determination, receive the overage passcode, authorize the transaction, etc.) during the transaction involving the transaction machine and the holder and/or while the holder is still at the transaction machine.

The apparatus configured to perform the process flow 100 can be configured to perform any of the portions of the process flow 100 represented by blocks 110-140 upon or after one or more triggering events (which, in some embodiments, is one or more of the other portions of the process flow 100). As used herein, a “triggering event” refers to an event that automatically (i.e., without human intervention) triggers the execution, performance, and/or implementation of a triggered action, either immediately, nearly immediately, or sometime after (e.g., within minutes, etc.) the occurrence of the triggering event. For example, in some embodiments, the apparatus configured to perform the process flow 100 is configured such that the apparatus receiving the transaction information (the triggering event) automatically and immediately or nearly immediately (e.g., within 3-30 seconds, etc.) triggers the apparatus to make the overage determination (the triggered action). In some embodiments, the apparatus is additionally or alternatively configured to authorize and/or complete the transaction (triggered action) automatically and immediately or nearly immediately after receiving the overage passcode (triggering event).

In accordance with some embodiments, the apparatus configured to perform the process flow 100 is configured to automatically perform one or more of the portions of the process flow 100 represented by blocks 110-140, whereas in other embodiments, one or more of the portions of the process flow 100 represented by blocks 110-140 require and/or involve human intervention (e.g., a user operating the apparatus configured to perform the process flow 100, etc.). In addition, it will be understood that, in some embodiments, the apparatus configured to perform the process flow 100 (and/or a user thereof) is configured to perform one or more portions (or combinations of portions) of the process flow 100, from start to finish, within moments, seconds, and/or minutes (e.g., within approximately 1-5 minutes from start to finish, etc.). As an example, in some embodiments, the apparatus having the process flow 100 is configured to authorize and/or complete the transaction within moments, seconds, and/or minutes (e.g., within approximately 1-5 minutes, etc.) of: (a) receiving the transaction information associated with the transaction; and/or (b) determining that the account will incur an overage as a result of the transaction.

As mentioned above, in some embodiments, the apparatus having the process flow 100 is configured to provide, implement, and/or is otherwise associated with an overage service. As used herein, the phrase “overage service” generally refers to a service that provides an account holder, account, and/or counterparty with the funds and/or credit necessary to complete an overage transaction. For example, in some embodiments, where a transaction, if completed, would overdraft a checking account by $10, the overage service can provide the checking account with the $10 needed to complete the transaction. In accordance with some embodiments, the overage service is referred to as an overdraft service if the account participating in the service is a deposit account. In other embodiments, the overage service is referred to as an over limit service if the account participating in the service is a credit account.

In some embodiments, as required by one or more laws, rules, and/or regulations (sometimes collectively referred to herein as “overage regulations” for simplicity), the holder must opt into the overage service before the holder can participate in and/or otherwise use the overage service. It will be understood that the holder may enroll in the overage service at a banking center, through an electronic banking account, via a call center, and/or in some other way. In addition, in some alternative embodiments, the apparatus having the process flow 100 is configured to prompt the holder to consent to, accept, and/or agree to (collectively referred to herein as “agree to” for simplicity) one or more terms of the overage service. In some embodiments, the apparatus prompts the holder to agree to the one or more terms of the overage service by prompting the holder to “opt into” and/or otherwise enroll in the overage service. In some of these embodiments, the apparatus prompts the holder during the transaction.

It will be understood that the overage service includes one or more terms, which define the one or more rights, responsibilities, privileges, fees, features, and/or obligations of the overage service. For example, in some embodiments, the one or more terms of the overage service describe how the overage service works; identify the overage service provider; define what constitutes an overage; identify the one or more overage fees charged for enrolling in the overage service, for participating in the overage service, and/or for engaging in an overage transaction; and/or the like. As another example, in some embodiments, the one or more terms of the overage service requires that the holder use the overage passcode in order to participate in the overage service.

In some embodiments, the overage service is provided by a financial institution, such as a bank, and is funded by that financial institution (and not by an account held by and/or otherwise associated with the holder). For example, in some embodiments, the overage service is provided by the same financial institution that maintains the transaction machine, the apparatus configured to perform the process flow 100, and/or the account that incurs, or will incur, the overage. It will be understood that, in some embodiments, the overage service (and/or the overage service provider) is regulated in the United States by the Electronic Funds Transfer Act, also known as Federal Reserve Board Regulation E (hereinafter “Regulation E”). In other embodiments, the overage service (and/or overage service provider) is regulated in the United States by the Credit Card Accountability Responsibility and Disclosure Act of 2009, which is codified in the United States as Public Law No. 111-24 (sometimes referred to herein, for simplicity, as the “Credit CARD Act of 2009” or the “CARD Act”). In some embodiments, the overage service does not contractually obligate the overage service provider to cover overages. In other words, in such embodiments, the overage service provider may choose to cover overdraft and/or over limit transactions at its discretion. However, in other embodiments, the overage service provider is contractually obligated and/or otherwise required to cover overages incurred by an account.

In some embodiments, one or more portions of the process flow 100 may be configured to comply with one or more portions of an overage regulation. For example, in some embodiments, receiving the overage passcode, as represented by block 130, may comply with one or more consent, opt-in, and/or revocation requirements of an overage regulation. As another example, in some alternative embodiments, the apparatus is configured to send the holder a confirmation message that indicates that the holder consented to the overage by providing the overage passcode, and in some embodiments, this confirmation message may comply with one or more confirmation requirements of an overage regulation.

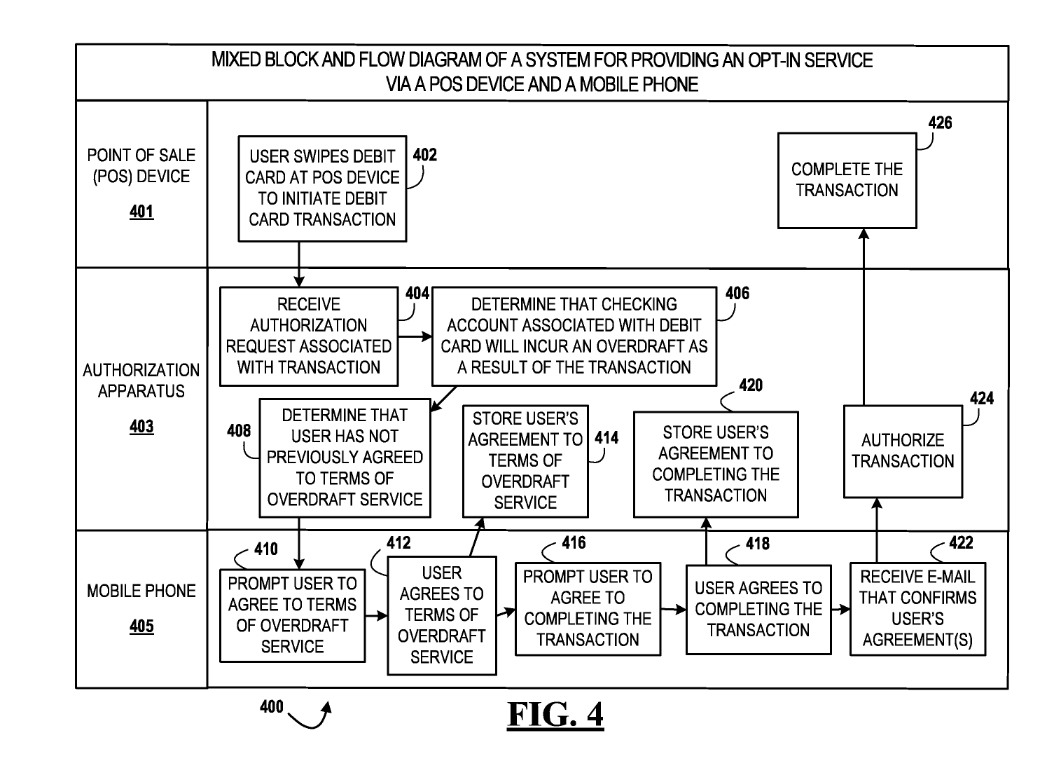

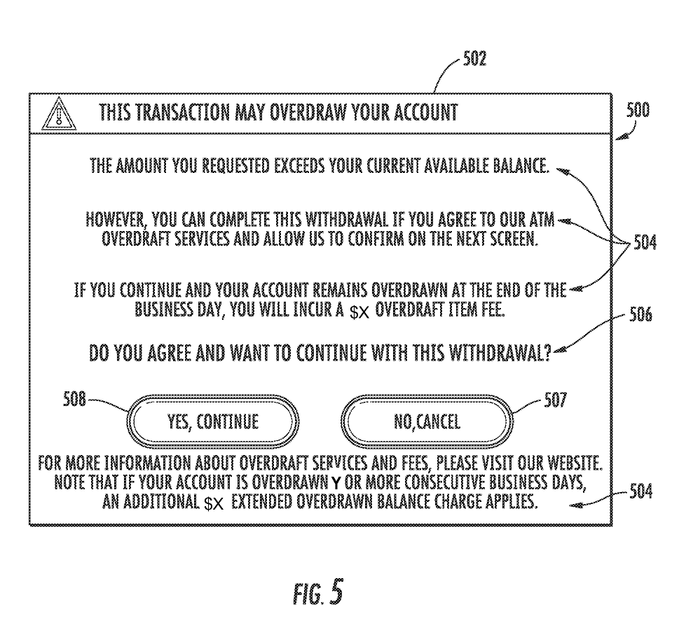

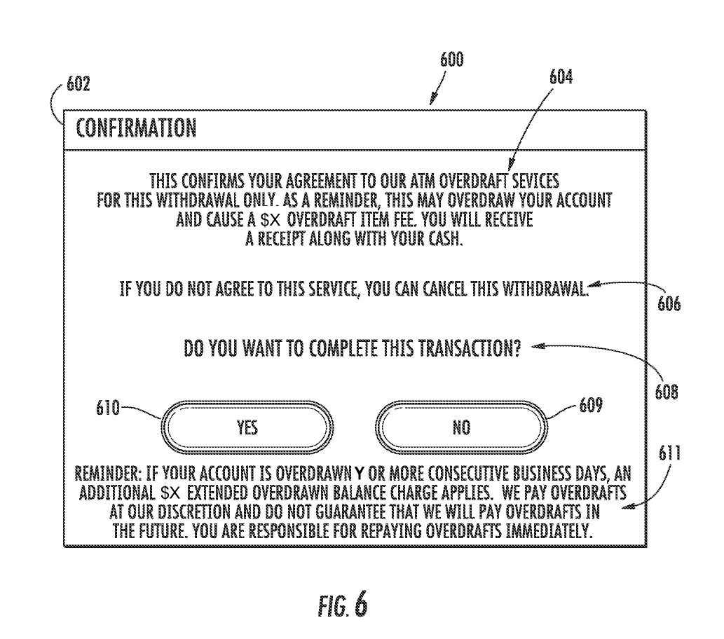

It will be understood that the apparatus having the process flow 100 can be configured to perform one or more portions of any embodiment described and/or contemplated herein, such as, for example, one or more portions of the process flow 200 described herein and/or one or more portions of the process flows described in connection with FIGS. 4 and/or 5. Also, the number, order, and/or content of the portions of the process flow 100 are exemplary and may vary. For example, in some embodiments, the apparatus having the process flow 100 is configured to assess a fee associated with the overage (e.g., charge an overage fee to the account and/or to the holder, etc.), where the fee is based at least partially on the account incurring an overage, on the account using the overage service, on the amount of the overage, and/or on authorizing and/or completing the transaction. In some embodiments, the apparatus is configured to: (a) assess the account an overage fee based at least partially on the apparatus determining that the account settled negative at the end of the day in which the transaction occurred; and/or (b) determine not to assess the account an overage fee based at least partially on the apparatus determining that the account settled non-negative (e.g., the account has a zero or positive available balance, etc.) at the end of the day in which the transaction occurred.

As another example, in some embodiments, the apparatus is configured to determine whether the overage passcode has been received in order to determine whether the holder has consented to the overage. In some of these embodiments, the apparatus is configured to store (e.g., in a datastore) the holder's consent to the overage (and/or evidence that the holder provided the overage passcode), which may, in some embodiments, be required by one or more overage regulations. As a further example, in some embodiments, the apparatus (and/or the transaction machine referred to in block 110) is configured to authenticate the holder as a condition of receiving the overage passcode and/or providing overage service. In some embodiments, the apparatus (and/or transaction machine) is configured to authenticate the holder based at least partially on account information (e.g., ATM/debit/credit card, account number, username, passcode, biometric information, barcode, etc.) the holder inserts, provides, and/or presents (collectively referred to herein as “presents” for simplicity) to the transaction machine and/or to the apparatus having the process flow 100.

As a further example of an additional or alternative portion, in some embodiments, the apparatus having the process flow 100 is configured to generate and/or send disclosure information to the holder (i.e., in addition to any disclosure information referred to in the process flow 100) before the overage transaction is initiated, before the holder approaches the transaction machine, before the apparatus receives the transaction information, and/or before the apparatus receives the overage passcode. For example, in some embodiments, before the apparatus receives the transaction information, the apparatus is configured to generate and/or send disclosure information to the holder that defines one or more terms of an overage service. This disclosure information can be sent via one or more emails, telephone calls, text messages, instant messages, IVR communications, communications specific to one or more social media networks and/or applications, direct mailings, electronic banking account-specific messages, and/or the like. In some embodiments, the disclosure information is included in one or more communications typically sent to a holder, such as, for example, a periodic (e.g., monthly) account statement. In other embodiments, instead of sending the disclosure information before the overage transaction is initiated, the apparatus having the process flow 100 is configured to the send the disclosure information to the holder during the transaction (e.g., via the holder's mobile device and/or the transaction machine, etc.), so that the holder can review and consent to the one or more terms of the overage service during the transaction and/or while the holder is at the transaction machine. In some of these embodiments, the holder can enroll in the overage service at the transaction machine, after the overage transaction has been initiated, and/or before the overage transaction has been completed. In some embodiments, sending the disclosure information to the holder may help a financial institution comply with one or more requirements of an overage regulation.

Referring now to FIG. 2, a more-detailed process flow 200 is illustrated for providing an overage service using an overage PIN, in accordance with an embodiment of the present invention. It will be understood that the process flow 200 illustrated in FIG. 2 represents an example embodiment of the process flow 100 described in connection with FIG. 1. In accordance with some embodiments, one or more portions of the process flow 200 are performed by an apparatus having hardware and/or software configured to perform one or more portions of the process flow 200. For example, in some embodiments, one or more portions of the process flow 200 are performed, individually or collectively, by the transaction machine 320 described in connection with FIG. 3, the authorization apparatus 330, the mobile device 340, and/or by any one or more portions (e.g., applications, etc.) thereof. Also, the apparatus having the process flow 200 may include, be included in, be embodied as, and/or be operatively connected to the transaction machine referred to in the process flow 200. In accordance with some embodiments, the apparatus having the process flow 200 is maintained by a bank for the benefit of its customers. Also in accordance with some embodiments, the customer referred to in the process flow 200 is the user of the transaction machine and a customer of the bank. In addition, the account referred to in the process flow 200 is an account held by the customer and maintained by the bank.

As represented by block 205, the bank customer enrolls in an overage service provided by the bank, such as, for example, by mail, banking center, call center, online banking, mobile banking application, and/or the like. During enrollment and/or as a result of enrolling, the apparatus having the process flow 200 assigns (and/or the customer selects) an overage PIN for use in future overage transactions, as represented by block 210. For example, in some embodiments, the customer selects an overage PIN that is easy to remember and/or similar to the primary PIN already associated with the customer, the customer's account, and/or the customer's debit and/or credit card (e.g., the customer selects “1227” as the overage PIN because the primary PIN is “1226”). After the overage PIN is selected by or assigned to the customer and/or account, the apparatus having the process flow 200 stores the overage PIN in a datastore (e.g., the account datastore 338, etc.), as represented by block 215. In some embodiments, the overage PIN is stored in an account profile associated with the account, where the account profile and many other account profiles are stored in the datastore.

Sometime after the customer enrolls in the overage service, the customer approaches a transaction machine (e.g., POS device, ATM, personal computer, etc.) for the purpose of engaging in a transaction using the transaction machine, as represented by block 220. Thereafter, the customer presents account information and inputs the primary PIN at the transaction machine, as represented by block 225. For example, in some embodiments where the transaction machine is a POS device, the customer swipes a debit and/or credit card associated with the customer's account through the POS device in order to communicate account information (e.g., information associated with the customer, the account, the debit and/or credit card, etc.) to the POS device and/or to the apparatus having the process flow 200. In such embodiments, the customer also inputs, into a user interface of the POS device, the primary PIN that is associated with the debit and/or credit card (and/or the account) and that is required to engage in transactions using the debit and/or credit card (and/or account). As another example, in some embodiments where the transaction machine is a personal computer, the customer inputs a credit card number and the primary PIN associated with the credit card (and/or account) into a field of a web page, where the web page is associated with the transaction and is displayed at the personal computer.

After the customer presents the account information and the primary PIN at the transaction machine, the apparatus having the process flow 200 (and/or the transaction machine) identifies and/or authenticates the customer, as represented by block 230. In some embodiments, the customer is identified and/or authenticated based at least partially on the account information and/or the primary PIN presented by the customer at the transaction machine. After being identified and/or authenticated, the customer selects the transaction and/or agrees to the transaction amount, as represented by block 235. Then, as represented by block 240, the transaction machine sends an authorization request to the apparatus having the process flow 200, where the authorization request identifies and/or describes the transaction, the customer, the account, the debit and/or credit card, the account information, the primary PIN, and/or the like.

Upon receiving the authorization request, the apparatus having the process flow 200 determines that the customer's account will incur an overage as a result of the transaction (e.g., the account has insufficient available funds and/or credit to cover the transaction, etc.), as represented by block 245. Thereafter, the apparatus is configured to decline the authorization request and/or otherwise decline, cancel, abort, and/or reject the transaction, as represented by block 250.

In addition, as represented by block 255, the apparatus having the process flow 200 is configured to prompt the customer to input the overage PIN at the transaction machine. The customer may be prompted in any way. For example, in some embodiments, the apparatus having the process flow 200 is configured to prompt the customer by sending a message to the transaction machine referred to in block 220 and/or to a mobile device accessible to (e.g., carried by, controlled by, etc.) the customer during the transaction, where the message prompts the customer to input the overage PIN into the transaction machine. The message may be any number and/or type of communication(s). For example, the message sent may be one or more text messages, phone calls, emails, actionable alerts, audible outputs, mobile banking application-specific messages, social media-specific messages (e.g., Facebook®-specific message, Twitter®-specific message, etc.), and/or the like. The message may be generated, rendered, displayed, and/or otherwise output visually (e.g., via a display) and/or audibly (e.g., via a speaker). In addition, the message may include any amount and/or type of information. For example, in some embodiments, the message includes explicit instructions for the holder to input the overage PIN into the transaction machine (e.g., “You have engaged in a transaction at Store A that will overdraft your checking account. Please input your overdraft PIN into the POS device at Store A if you agree to overdraft your account in order to complete the transaction”). Additionally or alternatively, the message may implicitly prompt the customer to input the overage PIN by notifying the customer of the overage, an overage fee associated with the overage, one or more terms of the overage service, and/or the like.

In some embodiments, the apparatus is configured to send the message and/or otherwise prompt the customer within about fourteen (14) seconds of: (a) declining the authorization request; (b) determining that the account will incur an overage; (c) receiving the authorization request; and/or (d) the transaction machine sending the authorization request. Further, in some embodiments, in addition to prompting the customer to input the overage PIN, the apparatus having the process flow 200 is configured to prompt the customer to re-present the account information (e.g., re-swipe the debit and/or credit card) referred to in connection with block 225. In some embodiments, the customer is sent a message that explicitly instructs the customer to re-present the account information, and in some embodiments, this message is the same message that prompts the customer to input the overage PIN.

In some alternative embodiments, instead of the customer selecting or being assigned the overage PIN during the enrollment process, the customer is first provided the overage PIN via the prompting represented by block 255 and/or at some point after initiating the overage transaction. For example, in some alternative embodiments, the apparatus having the process flow 200 is configured to send a message to the customer after the apparatus determines that the account will incur the overage, where the message: (a) notifies the customer of the overage, an overage fee associated with incurring the overage, one or more terms associated with an overage service, etc.; (b) provides the customer with the overage PIN for use in completing the overage transaction; and/or (c) prompts the customer to input the overage PIN into the transaction machine (and/or re-present the account information) if the customer wishes to complete the overage transaction and/or to incur the overage fee. In some embodiments, the overage PIN that is provided to the customer after the overage transaction has been initiated is a dynamically-generated and/or one-time overage PIN, and/or is valid for only one overage transaction and/or for only the overage transaction referred to in the process flow 200.

Referring again to FIG. 2, after being prompted, the customer inputs the overage PIN into the transaction machine and/or re-presents the account information (and/or presents other account information) to the transaction machine, as represented by block 260. For example, in some embodiments where the transaction machine is a POS device, the customer can re-swipe his debit and/or credit card through POS device and/or input the overage PIN into a keypad of the transaction machine in order to re-initiate and/or complete the overage transaction. In some embodiments, by inputting the overage PIN into the transaction machine, the customer may consent, either explicitly or implicitly, to one or more terms of an overage service, to incurring an overage fee associated with the overage, to completing the overage transaction, and/or the like. Also, it will be understood that the customer may input his overage PIN into the transaction machine in any way (e.g., using a keypad, microphone, touchscreen display, etc.).

It will be understood that, in this example embodiment, the apparatus having the process flow 200 is configured to prompt the customer during the transaction (e.g., while the holder is still at and/or near the transaction machine). As such, the customer may decline the overage coverage (e.g., by declining to input the overage PIN) because, for example, the transaction involves a relatively small and/or discretionary purchase. However, in other cases, the customer may accept the overage coverage because the transaction involves a relatively large and/or an emergency and/or non-discretionary purchase. Either way, the customer is empowered with making this decision, which reduces or eliminates the possibility that the customer will unknowingly or unexpectedly engage in an overdraft transaction (and/or unknowingly or unexpectedly incur an overdraft fee). In addition, because the apparatus prompts the customer during the transaction, the customer is able to make this decision in real-time and/or on a per-transaction basis. Further, the apparatus may also enable the customer to make this decision discreetly (e.g., by prompting the customer via the customer's mobile phone), thereby avoiding any embarrassment associated with the overage, the overage fee, the overage service, and/or the like.

After the customer inputs the overage PIN and/or re-presents the account information, the transaction machine sends a second authorization request to the apparatus having the process flow 200, where the second authorization request identifies and/or describes the transaction, the customer, the account, the debit and/or credit card, the account information, the primary PIN, the overage PIN, and/or the like, as represented by block 265. In some embodiments, the information sent in the second authorization request is similar and/or identical to the information sent in the first authorization request referred to in connection with block 240, except that the second authorization request includes the overage PIN and the first authorization request does not.

After receiving the second authorization request, the apparatus determines that the overage PIN sent in the second authorization request matches the overage PIN stored in the datastore, as represented by block 270. For example, in some embodiments, the apparatus is configured to compare the overage PIN sent in the second authorization request to an overage PIN that is stored in the account profile associated with the account. If the two overage PINs match, the apparatus having the process flow 200 is configured to approve the second (and/or first) authorization request, authorize the overage transaction, and/or instruct the transaction machine to complete the overage transaction, as represented by block 275. Thereafter, the transaction machine completes the overage transaction (e.g., by dispensing cash, completing a credit card payment, etc.), as represented by block 280. After the overage transaction is completed, the customer leaves the transaction machine, as represented by block 285.

In accordance with some embodiments, one or more portions of the process flow 200 may comply with one or more requirements of an overage regulation (e.g., Regulation E and/or the CARD Act in the United States, etc.). For example, in some embodiments, receiving the customer's overage PIN at the transaction machine, as represented by block 260 may comply with one or more consent requirements of an overage regulation because, in some embodiments, the customer may consent to the overage, the overage fee, the overage transaction, and/or one or more terms of an overage service by inputting the overage PIN into the transaction machine. In addition, in some embodiments, the apparatus completing the overage transaction may comply with one or more overage regulation requirements because, for example, the customer inputted the overage PIN and was authenticated, all before the overage transaction was completed.

Of course, it will also be understood that the embodiment illustrated in FIG. 2 is merely exemplary and that other embodiments may vary without departing from the scope and spirit of the present invention. For example, in some alternative embodiments, the primary and overage PINs referred to in the process flow 200 are passwords, usernames, strings, and/or some other type of passcode. As another example, in some alternative embodiments, the apparatus may receive the overage PIN as a result of the customer inputting the overage PIN into a mobile device (e.g., mobile phone) carried by and/or accessible to the customer during the transaction. In some embodiments, the apparatus is additionally or alternatively configured to prompt the customer to input the overage PIN into the mobile device. As another example, in some alternative embodiments, the apparatus having the process flow 200 approves the first authorization request at block 275 because a second authorization request is never sent and/or is not required. In other words, the apparatus can be configured to hold the original authorization request until the overage PIN is received and the transaction is authorized, or until a predetermined period of time has elapsed.

As another example, in some alternative embodiments, the portion of the process flow 200 represented by block 255 is omitted. In other words, in such embodiments, the customer is not explicitly prompted to input the overage PIN at the transaction machine after the overage transaction is declined; instead, the customer just knows, after and/or as a result of being declined, to input the overage PIN and/or re-present the account information at the transaction machine in order to complete the overage transaction. In some of these embodiments, the customer is prompted to input the overage PIN based at least partially on the transaction being declined (e.g., the declining the transaction implicitly prompts the customer to input the overage PIN).

In addition, in some alternative embodiments, before the apparatus compares the two PINs, the apparatus may first determine, based at least partially on the second transaction request and/or the information therein, that the account will incur an overage as a result of the transaction. In other words, in some embodiments, the apparatus may be configured to treat and/or otherwise process the second authorization request as if it were a new authorization request. In such embodiments, the apparatus may be configured to regularly access the datastore to determine whether the PIN sent in the authorization request matches the overage PIN that is stored in the datastore and associated with the account.

In addition, it will also be understood that the apparatus having the process flow 200 can be configured to perform one or more portions of the process flow 200 in real time, in substantially real time, and/or at one or more predetermined times. The apparatus having the process flow 200 may be configured to perform any of the portions of the process flow 200 represented by blocks 205-280 upon or after one or more triggering events (which, in some embodiments, is the performance of one or more of the other portions of the process flow 200). In addition, in some embodiments, the apparatus having the process flow 200 (and/or a customer thereof) is configured to perform one or more portions (or combinations of portions) of the process flow 200, from start to finish, within moments, seconds, and/or minutes (e.g., within approximately 1-15 minutes, etc.).

Referring now to FIG. 3, a system 300 for providing an overage service using an overage passcode is provided, in accordance with an embodiment of the present invention. As illustrated, the system 300 includes a network 310, a transaction machine 320, an authorization apparatus 330, and a mobile device 340. FIG. 3 also shows an account holder 302 and a profile 308 of an account (e.g., checking account, savings account, credit card account, LOC account, HELOC account, etc.), where the profile 308 is stored in the account datastore 338 of the authorization apparatus 330. The account is held by the holder 302, maintained by a financial institution at which the holder 302 is a customer, and is associated with the account profile 308. As shown, the account profile 308 includes account information 308A associated with the account (and/or holder 302), a primary passcode 308B associated with the account (and/or holder 302), and an overage passcode 308C associated with the account (and/or holder 302). In some embodiments, the holder 302 may access the account profile 308 via online banking, mobile banking, and/or text banking (e.g., by using the mobile device 340, the transaction machine 320, and/or some other apparatus). Also, as shown, the holder 302 has access to the mobile device 340 and the transaction machine 320. In accordance with some embodiments, the transaction machine 320 and the authorization apparatus 330 are each maintained by the same financial institution. For example, in some embodiments, the holder 302 is a customer of the financial institution, the authorization apparatus 330 is embodied as an ATM transaction server maintained by the financial institution, and the transaction machine 320 is embodied as an ATM maintained by the financial institution. However, in other embodiments, the transaction machine 320 and the authorization apparatus 330 are maintained by separate entities. For example, in some embodiments, the transaction machine 320 is embodied as a POS device maintained by a merchant, and the authorization apparatus 330 is embodied as an authorization server maintained by a financial institution. In accordance with some embodiments, the mobile device 340 is associated with the holder 302 and/or is carried, owned, possessed, and/or owned by the holder 302.

As shown in FIG. 3, the transaction machine 320, the authorization apparatus 330, and the mobile device 340 are each operatively and selectively connected to the network 310, which may include one or more separate networks. The network 310 may include one or more payment networks (e.g., interbank networks, Visa's® payment network VisaNet®, MasterCard's® payment network BankNet®, any wireline and/or wireless network over which payment information is sent, etc.), telephone networks (e.g., cellular networks, CDMA networks, any wireline and/or wireless network over which communications to telephones and/or mobile phones are sent, etc.), local area networks (LANs), wide area networks (WANs), global area networks (GANs) (e.g., the Internet, etc.), and/or one or more other telecommunications networks. For example, in some embodiments, the network 310 includes a telephone network (e.g., for communicating with the mobile device 340, etc.) and a payment network (e.g., for communicating with the transaction machine 320, etc.). It will also be understood that the network 310 may be secure and/or unsecure and may also include wireless and/or wireline technology.

The transaction machine 320 may include any computerized apparatus that can be configured to perform any one or more of the functions of the transaction machine 320 described and/or contemplated herein. It will also be understood that the transaction machine 320 can include and/or be embodied as, any transaction machine described and/or contemplated herein. It will further be understood that the transaction machine 320 can initiate, perform, complete, and/or otherwise facilitate any transaction described and/or contemplated herein as being initiated, performed, and/or otherwise facilitated by a transaction machine. For example, in some embodiments, the transaction machine 320 includes and/or is embodied as an ATM, a POS device, a self-checkout machine, a vending machine, a ticketing kiosk, a personal computer, a gaming device, a mobile phone, and/or the like. As another example, in some embodiments, the transaction machine 320 is configured to initiate, perform, complete, and/or otherwise facilitate one or more financial and/or non-financial transactions, including, for example, purchasing, renting, selling, and/or leasing goods and/or services (e.g., groceries, stamps, tickets, gift certificates, DVDs, etc.); withdrawing cash; making deposits (e.g., cash, checks, etc.); making payments (e.g., paying telephone bills, sending remittances, etc.); accessing and/or navigating the Internet; and/or the like.

In some embodiments, the transaction machine 320 (and/or one or more other portions of the system 300) requires its users to authenticate themselves to the transaction machine 320 (and/or one or more other portions of the system 300) before the transaction machine 320 will initiate, perform, complete, and/or facilitate a transaction. For example, in some embodiments, the transaction machine 320 (and/or the transaction application 327) is configured to authenticate a transaction machine user based at least partially on an ATM/debit/credit card, loyalty/rewards/club card, smart card, token (e.g., USB token, etc.), username/password, PIN, biometric information, and/or one or more other credentials that the user presents to the transaction machine 320. Additionally or alternatively, in some embodiments, the transaction machine 320 is configured to authenticate a user by using one-, two-, or multi-factor authentication. For example, in some embodiments, the transaction machine 320 requires two-factor authentication, such that the holder 302 must provide a valid debit card and enter the correct PIN associated with the debit card in order to authenticate the holder 302 to the transaction machine 320.

As illustrated in FIG. 3, in accordance with some embodiments of the present invention, the transaction machine 320 includes a communication interface 322, a processor 324, a memory 326 having a transaction application 327 stored therein, and a user interface 329. In such embodiments, the processor 324 is operatively and selectively connected to the communication interface 322, the user interface 329, and the memory 326.

Each communication interface described herein, including the communication interface 322, generally includes hardware, and, in some instances, software, that enables a portion of the system 300, such as the transaction machine 320, to send, receive, and/or otherwise communicate information to and/or from the communication interface of one or more other portions of the system 300. For example, the communication interface 322 of the transaction machine 320 may include a modem, network interface controller (NIC), NFC interface, network adapter, network interface card, and/or some other electronic communication device that operatively connects the transaction machine 320 to another portion of the system 300, such as, for example, the authorization apparatus 330.

Each processor described herein, including the processor 324, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the transaction application 327 of the memory 326 of the transaction machine 320.

Each memory device described herein, including the memory 326 for storing the transaction application 327 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

As shown in FIG. 3, the memory 326 includes the transaction application 327. It will be understood that the transaction application 327 can be operable (e.g., usable, executable, etc.) to initiate, perform, complete, and/or facilitate one or more portions of any embodiment described and/or contemplated herein, such as, for example, one or more portions of the process flows 100 and/or 200 described herein and/or one or more portions of the process flows described in connection with FIGS. 4 and/or 5. For example, in some embodiments, the transaction application 327 is operable to receive transaction information associated with a transaction. As another example, in some embodiments, the transaction application 327 is operable to determine, based at least partially on that transaction information, that an account (e.g., the account held by the holder 302, etc.) will incur an overage as a result of a transaction. In some embodiments, the transaction application 327 is operable to receive an overage passcode (e.g., the overage passcode 308C) associated with the account, and/or authorize a transaction based at least partially on receiving the overage passcode. In still other embodiments, the transaction application 327 is operable to complete one or more transactions at the transaction machine 320 (e.g., complete a purchase transaction, dispense cash, accept a check for deposit, etc.). As a further example, in some embodiments, the transaction application 327 is operable to prompt the holder 302 to input a passcode (e.g., the primary passcode 308B, the overage passcode 308C) into the transaction machine (e.g., into the user interface 329). In still other embodiments, the transaction application 327 is operable to generate and/or send authorization requests associated with one or more transactions to the authorization apparatus 330.

In some embodiments, where the transaction machine 320 includes and/or is embodied as an ATM, the transaction application 327 is configured to execute on the ATM in order to initiate, perform, complete, and/or facilitate, for example, one or more cash withdrawals, deposits, and/or the like. In other embodiments, where the transaction machine 320 includes and/or is embodied as a POS device, the transaction application 327 is configured to execute on the POS device in order to initiate, perform, complete, and/or facilitate, for example, one or more debit card and/or credit card transactions. In still other embodiments, where the transaction machine 320 includes and/or is embodied as a personal computer, the transaction application 327 is configured to execute on the personal computer, and, in some embodiments, the transaction application 327 is embodied as a web browser (i.e., for navigating the Internet, etc.) that is operable to initiate, perform, complete, and/or otherwise facilitate one or more financial and/or non-financial transactions.

In some embodiments, the transaction application 327 is operable to enable the holder 302 and/or transaction machine 320 to communicate with one or more other portions of the system 300, and/or vice versa. In some embodiments, the transaction application 327 is additionally or alternatively operable to initiate, perform, complete, and/or otherwise facilitate one or more financial and/or non-financial transactions. In some embodiments, the transaction application 327 includes one or more computer-executable program code portions for causing and/or instructing the processor 324 to perform one or more of the functions of the transaction application 327 and/or transaction machine 320 described and/or contemplated herein. In some embodiments, the transaction application 327 includes and/or uses one or more network and/or system communication protocols.

As shown in FIG. 3, the transaction machine 320 also includes the user interface 329. It will be understood that the user interface 329 (and any other user interface described and/or contemplated herein) can include and/or be embodied as one or more user interfaces. It will also be understood that, in some embodiments, the user interface 329 includes one or more user output devices for presenting information and/or one or more items to the transaction machine user (e.g., the holder 302, etc.), such as, for example, one or more displays, speakers, receipt printers, dispensers (e.g., cash dispensers, ticket dispensers, merchandise dispensers, etc.), and/or the like. In some embodiments, the user interface 329 additionally or alternatively includes one or more user input devices, such as, for example, one or more buttons, keys, dials, levers, directional pads, joysticks, keyboards, keypads, mouses, accelerometers, controllers, microphones, touchpads, touchscreens, haptic interfaces, styluses, scanners, biometric readers, motion detectors, cameras, card readers (e.g., for reading the magnetic strip on magnetic cards such as ATM, debit, credit, and/or bank cards, etc.), deposit mechanisms (e.g., for depositing checks and/or cash, etc.), and/or the like for receiving information from one or more items and/or from the transaction machine user (e.g., the holder 302, etc.). In some embodiments, the user interface 329 and/or the transaction machine 320 includes one or more vaults, security sensors, locks, and/or anything else typically included in and/or near the transaction machine.

FIG. 3 also illustrates an authorization apparatus 330, in accordance with an embodiment of the present invention. The authorization apparatus 330 may include any computerized apparatus that can be configured to perform any one or more of the functions of the authorization apparatus 330 described and/or contemplated herein. It will also be understood that the authorization apparatus 330 can include and/or be embodied as any authorization apparatus described and/or contemplated herein. It will further be understood that the authorization apparatus 330 can initiate, perform, complete, and/or otherwise facilitate any transaction described and/or contemplated herein as being initiated, performed, and/or otherwise facilitated by an authorization apparatus. In some embodiments, the authorization apparatus 330 includes and/or is embodied as one or more servers, engines, mainframes, personal computers, ATMs, network devices, front end systems, back end systems, and/or the like. In some embodiments, such as the one illustrated in FIG. 3, the authorization apparatus 330 includes a communication interface 332, a processor 334, and a memory 336, which includes an authorization application 337 and an account datastore 338 stored therein. As shown, the communication interface 332 is operatively and selectively connected to the processor 334, which is operatively and selectively connected to the memory 336.

The authorization application 337 can be operable (e.g., usable, executable, etc.) to initiate, perform, complete, and/or facilitate any one or more portions of the process flows 100 and/or 200 described herein and/or one or more portions of the process flows described in connection with FIGS. 4 and/or 5. For example, in some embodiments, the authorization application 337 is operable to receive transaction information associated with a transaction. As another example, in some embodiments, the authorization application 337 is operable to determine, based at least partially on that transaction information, that an account (e.g., the account, etc.) will incur an overage as a result of a transaction. In some embodiments, the authorization application 337 is operable to receive an overage passcode (e.g., the overage passcode 308C) associated with the account, and/or authorize a transaction based at least partially on receiving the overage passcode.

As another example, in some embodiments, the transaction application 327 is operable to prompt the holder 302 to input a passcode (e.g., the primary passcode 308B, the overage passcode 308C) into the transaction machine (e.g., into the user interface 329) and/or the mobile device 340. In some of these embodiments, the authorization application 337 prompts the holder 302 via the user interface 329 of the transaction machine 320 and/or via the user interface 349 of the mobile device 340. In some embodiments, the authorization application 337 receiving the overage passcode from the holder 302 serves to indicate that the holder 302 consents to incurring an overage amount, to incurring an overage fee, to completing an overage transaction, and/or to one or more terms of an overage service. Also, in some embodiments, the authorization application 337 is operable to receive the primary passcode and/or overage passcode from the holder 302 via the mobile device 340 and/or via the transaction machine 320.

As another example, in some embodiments, the authorization application 337 is operable to generate and/or send disclosure information to the holder 302, where the disclosure information defines one or more terms of an overage service. In some embodiments, the authorization application 337 generates and/or sends this disclosure information to the holder 302 prior to the holder 302 initiating and/or engaging in a transaction at the transaction machine 320. However, in other embodiments, the authorization application 337 is operable to send the disclosure information to the holder 302 during the overage transaction and/or while the holder 302 is standing at the transaction machine 320. Also, in some embodiments, the authorization application 337 is further operable to prompt the holder 302 (e.g., via the user interface 329, via the user interface 349, during the overage transaction, etc.) to agree to the one or more terms of the overage service defined in the disclosure information. In some embodiments, the authorization application 337 is operable to send a confirmation message to the holder 302 that confirms receipt of the holder's overage passcode and/or that confirms the holder's consent to the overage and/or to completing the transaction. In some embodiments, the authorization application 337 is operable to perform one or more of these (and/or other) functions, such that a financial institution may comply with one or more overage regulation requirements (e.g., Regulation E in the United States, etc.).

In some embodiments, the authorization application 337 is operable to enable the authorization apparatus 330 to communicate with one or more other portions of the system 300, such as, for example, the account datastore 338, the mobile device 340, and/or the transaction machine 320, and/or vice versa. In addition, in some embodiments, the authorization application 337 is operable to initiate, perform, complete, and/or otherwise facilitate one or more financial and/or non-financial transactions. In some embodiments, the authorization application 337 includes one or more computer-executable program code portions for causing and/or instructing the processor 334 to perform one or more of the functions of the authorization application 337 and/or the authorization apparatus 330 that are described and/or contemplated herein. In some embodiments, the authorization application 337 includes and/or uses one or more network and/or system communication protocols.

In addition to the authorization application 337, the memory 336 also includes the account datastore 338. As shown, the account datastore 338 stores the account profile 308, which includes account information 308A, the primary passcode 308B, and the overage passcode 308C. The account information 308A may include any information associated with the account held by the holder 302, including, for example, information associated with one or more account holders (e.g., holder 302), transaction histories, when the account last used an overage service, account preferences, billing information, the terms and conditions associated with the account, and/or the like. The primary passcode 308B may include any information associated with a primary passcode, such as, for example, the primary passcode itself (e.g., “3578,” “235145,” “chiefs,” etc.), when the primary passcode was selected by the holder 302 or assigned by the financial institution maintaining the account and/or providing the overage service, when the primary passcode was last used, etc. The overage passcode 308C may include any information associated with an overage passcode, including, for example, the overage passcode itself (e.g., “4598,” “12345,” “overdraft123,” etc.), when the overage passcode was selected by the holder 302 or assigned by the financial institution maintaining the amount and/or providing the overage service, when the overage passcode was last used, any one or more conditions associated with using the overage passcode (e.g., the overage passcode may be used to complete ATM transactions but not POS device transactions, to consent to overages of $45 or more, etc.).

It will be understood that the account datastore 338 can be configured to store any type and/or amount of information. In addition to the account profile 308, the account datastore 338 may include information associated with one or more account holders (e.g., the holder 302, account holders other than the holder 302), account profiles (i.e., other than the account profile 308), financial accounts (i.e., other than the account held by the holder 302), transaction machines, transaction machine users, transactions, overages, electronic banking accounts, primary passcodes, overage passcodes, mobile devices, overage services, authorization requests, overage regulations, and/or the like. In some embodiments, the account datastore 338 may also store any information related to providing an overage service using an overage passcode. In some embodiments, the account datastore 338 additionally or alternatively stores information associated with electronic banking (e.g., online banking, mobile banking, text banking, etc.) and/or electronic banking accounts.

In accordance with some embodiments, the account datastore 338 may include any one or more storage devices, including, but not limited to, datastores, databases, and/or any of the other storage devices typically associated with a computer system. It will also be understood that the account datastore 338 may store information in any known way, such as, for example, by using one or more computer codes and/or languages, alphanumeric character strings, data sets, figures, tables, charts, links, documents, and/or the like. Further, in some embodiments, the account datastore 338 includes information associated with one or more applications, such as, for example, the authorization application 337 and/or the transaction application 327. In some embodiments, the account datastore 338 provides a real-time or near real-time representation of the information stored therein, so that, for example, when the processor 334 accesses the account datastore 338, the information stored therein is current or nearly current. Although not shown, in some embodiments, the transaction machine 320 includes a transaction datastore that is configured to store any information associated with the transaction machine 320, the transaction application 327, and/or the like. It will be understood that the transaction datastore can store information in any known way, can include information associated with anything shown in FIG. 3, and/or can be configured similar to the account datastore 338.

Referring now to FIG. 3A, a block diagram is provided that illustrates the mobile device 340 of FIG. 3 in more detail, in accordance with an embodiment of the invention. In some embodiments, the mobile device 340 is a mobile phone (e.g., feature phones, smart phones, iPhones®, Droids®, etc.), but in other embodiments, the mobile device 340 can include and/or be embodied as any other mobile device, including, but not limited to, mobile gaming devices (e.g., PlayStation Portable®, etc.), mobile computers (e.g., tablet computers, laptop computers, etc.), personal digital assistants (PDAs), and/or the like. In some embodiments, the mobile device is configured to send and/or receive communications (e.g., phone calls, text messages, actionable alerts, emails, social media-specific messages, etc.), present information via a user interface, play video games, and/or the like. In some embodiments, the mobile device is portable (e.g., not stationary) and/or can be carried and/or worn by and/or on a person. As shown in FIG. 3A, the mobile device 340 generally includes a processor 344 operatively connected to such devices as a memory 346, user interface 349 (i.e., user output devices 349A and user input devices 349B), a communication interface 342, a power source 345, a clock or other timer 343, a camera 341, and a positioning system device 390.

The processor 344 may include the functionality to encode and interleave messages and data prior to modulation and transmission. The processor 344 can additionally include an internal data modem. Further, the processor 344 may include functionality to operate one or more software programs, which may be stored in the memory 346. For example, the processor 344 may be capable of operating a connectivity program, such as a web browser application 348. The web browser application 348 may then allow the mobile device 340 to transmit and receive web content, such as, for example, location-based content and/or other web page content, according to a Wireless Application Protocol (WAP), Hypertext Transfer Protocol (HTTP), and/or the like.

The processor 344 is configured to use the communication interface 342 to communicate with one or more other devices on the network 310. In this regard, the communication interface 342 includes an antenna 376 operatively coupled to a transmitter 374 and a receiver 372 (together a “transceiver”). The processor 344 is configured to provide signals to and receive signals from the transmitter 374 and receiver 372, respectively. The signals may include signaling information in accordance with the air interface standard of the applicable cellular system of the wireless telephone network 310. In this regard, the mobile device 340 may be configured to operate with one or more air interface standards, communication protocols, modulation types, and access types. By way of illustration, the mobile device 340 may be configured to operate in accordance with any of a number of first, second, third, and/or fourth-generation communication protocols and/or the like. For example, the mobile device 340 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 340 may also be configured to operate in accordance with non-cellular communication mechanisms, such as via a wireless local area network (WLAN) or other communication/data networks.

The communication interface 342 may also include a near field communication (NFC) interface 370. As used herein, the phrase “NFC interface” generally refers to hardware and/or software that is configured to contactlessly and/or wirelessly send and/or receive information over relatively short ranges (e.g., within four inches, within three feet, within fifteen feet, etc.). The NFC interface 370 may include a smart card, key card, proximity card, Bluetooth® device, radio frequency identification (RFID) tag and/or reader, transmitter, receiver, and/or the like. In some embodiments, the NFC interface 370 communicates information via radio, infrared (IR), and/or optical transmissions. In some embodiments, the NFC interface 370 is configured to operate as an NFC transmitter and/or as an NFC receiver (e.g., an NFC reader, etc.). In some embodiments, the NFC interface 370 enables the mobile device 340 to operate as a mobile wallet. Also, it will be understood that the NFC interface 370 may be embedded, built, carried, and/or otherwise supported in and/or on the mobile device 340. In some embodiments, the NFC interface 370 is not supported in and/or on the mobile device 340, but the NFC interface 370 is otherwise operatively connected to the mobile device 340 (e.g., where the NFC interface 370 is a peripheral device plugged into the mobile device 340, etc.). Other apparatuses having NFC interfaces mentioned herein may be configured similarly.

In some embodiments, the NFC interface 370 of the mobile device 340 is configured to contactlessly and/or wirelessly communicate information to and/or from a corresponding NFC interface of another apparatus (e.g., the transaction machine 320, etc.). For example, in some embodiments, the mobile device 340 is a mobile phone, the NFC interface 370 is a smart card having account information stored therein, and the transaction machine 320 is a POS device having an NFC reader operatively connected thereto. In such embodiments, when the mobile phone and/or smart card is brought within a relatively short range of the NFC reader, the smart card is configured to wirelessly and/or contactlessly send the account information to the NFC reader in order to, for example, initiate, perform, complete, and/or otherwise facilitate a transaction.

In addition to the NFC interface 370, the mobile device 340 can have a user interface 349 that is, like other user interfaces described herein, made up of one or more user output devices 349A and/or user input devices 349B. The user output devices 349A include a display 380 (e.g., a liquid crystal display and/or the like) and a speaker 382 and/or other audio device, which are operatively coupled to the processor 344. The user input devices 349B, which allow the mobile device 340 to receive data from a user such as the holder 302, may include any of a number of devices allowing the mobile device 340 to receive data from a user, such as a keypad, keyboard, touch-screen, touchpad, microphone, mouse, joystick, other pointer device, button, soft key, and/or other input device(s). The user interface 349 may also include a camera 341, such as a digital camera.

In some embodiments, the mobile device 340 also includes a positioning system device 390 that can be used to determine the location of the mobile device 340. For example, the positioning system device 390 may include a GPS transceiver. In some embodiments, the positioning system device 390 includes a compass. In some embodiments, the positioning system device 390 is at least partially made up of the antenna 376, transmitter 374, and receiver 372 described above. For example, in one embodiment, triangulation of cellular signals may be used to identify the approximate location of the mobile device 340. In other embodiments, the positioning system device 390 includes a proximity sensor and/or transmitter, such as an RFID tag, that can sense or be sensed by devices known to be located proximate a merchant and/or other location to determine that the mobile device 340 is located proximate these known devices.

The mobile device 340 further includes a power source 345, such as a battery, for powering various circuits and other devices that are used to operate the mobile device 340. Embodiments of the mobile device 340 may also include a clock or other timer 343 configured to determine and, in some cases, communicate actual or relative time to the processor 344 or one or more other devices.

The mobile device 340 also includes a memory 346 operatively connected to the processor 344. As used herein, memory includes any computer readable medium (as defined herein) configured to store data, code, and/or other information. The memory 346 may include volatile memory, such as volatile Random Access Memory (RAM) including a cache area for the temporary storage of data. The memory 346 may also include non-volatile memory, which can be embedded and/or may be removable. The non-volatile memory can additionally or alternatively include an electrically erasable programmable read-only memory (EEPROM), flash memory or the like.

The memory 346 can store any of a number of applications which may include computer-executable instructions/code executed by the processor 344 to implement the functions of the mobile device 340 described herein. For example, the memory 346 may include such applications as a web browser application 348 and/or a mobile banking application 347. It will be understood that the web browser application 348 and/or the mobile banking application 347 can be, individually or collectively, operable (e.g., usable, executable, etc.) to initiate, perform, complete, and/or facilitate any one or more portions of the process flows 100 and/or 200 described herein and/or one or more portions of the process flows described in connection with FIGS. 4 and/or 5. For example, in some embodiments, the mobile banking application 347 (and/or the web browser application 348) is operable to prompt, via the user interface 349, the holder 302 to input a primary passcode and/or an overage passcode into the transaction machine 320 and/or the mobile device 340. As still another example, in some embodiments, the mobile banking application 347 (and/or the web browser application 348) is operable to receive, via the user interface 349, the holder's 302 primary passcode and/or overage passcode. In still other embodiments, the mobile banking application 347 (and/or the web browser application 348) is operable to determine that the account will incur an overage as a result of a transaction. As still another example, in some embodiments, the mobile banking application 347 (and/or the web browser application 348) is operable to provide the holder 302 with a one-time, dynamic, random, and/or transaction-specific overage passcode, which may be input into the mobile device 340 and/or transaction machine 320 to, for example, consent to incurring an overage, to incurring an overage fee, to completing an overage transaction, and so on.

In some embodiments, these applications provide a graphical user interface (GUI) on the display 380 that allows the holder 302 to communicate with the mobile device 340, the transaction machine 320, the authorization apparatus 330, and/or one or more other portions of the system 300. In some embodiments, the holder 302 can use the mobile banking application 347 to access the electronic banking account 309 (e.g., mobile banking account, text banking account, etc.) that is associated with the account. The memory 346 can also store any type and/or amount information used by the mobile device 340, and/or used by the applications and/or the devices that make up the mobile device 340 and/or that are in communication with the mobile device 340, to implement the functions of the mobile device 340 and/or the other systems described and/or contemplated herein. For example, in some embodiments, the memory 346 stores account information (e.g., routing and/or account numbers, account names, username/passwords, primary passcodes, overage passcodes, biometric information, etc.) associated with the holder 302 and/or account.

The embodiments illustrated in FIGS. 3 and 3A are exemplary and other embodiments may vary. For example, in some embodiments, some or all of the portions of the system 300 are combined into a single portion. Specifically, in some embodiments, the transaction machine 320 and the authorization apparatus 330 are combined into a single transaction and authorization apparatus that is configured to perform all of the same functions of those separate portions as described and/or contemplated herein. Likewise, in some embodiments, some or all of the portions of the system 300 are separated into two or more distinct portions. In addition, the various portions of the system 300 may be maintained by the same or separate parties.

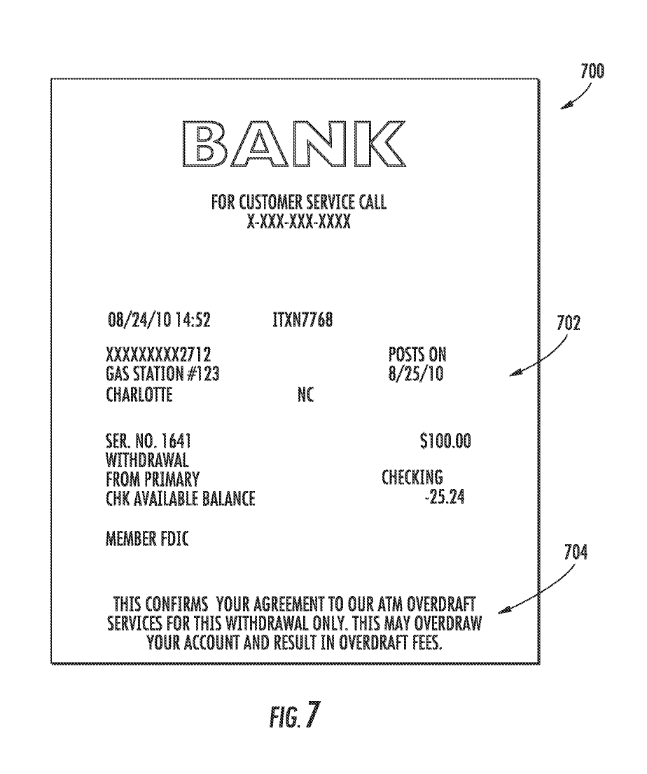

The system 300 and/or one or more portions of the system 300 may include and/or implement any embodiment of the present invention described and/or contemplated herein. For example, in some embodiments, the system 300 (and/or one or more portions of the system 300) is configured to implement any one or more embodiments of the process flow 100 described and/or contemplated herein in connection with FIG. 1, any one or more embodiments of the process flow 200 described and/or contemplated herein in connection with FIG. 2, any one or more embodiments of the process flow described and/or contemplated herein in connection with FIG. 4, and/or any one or more of embodiments of the process flow described and/or contemplated herein in connection with FIG. 5.

As a specific example, in accordance with an embodiment of the present invention, the authorization apparatus 330 is configured to: (a) receive transaction information associated with a transaction, where the transaction involves the account, the transaction machine 320, and the holder 302, and where the account is associated with the primary passcode 308B (e.g., “3456”), as represented by block 110 in FIG. 1; (b) determine, based at least partially on the transaction information, that the account will incur an overage as a result of the transaction, as represented by block 120; (c) receive (e.g., via the user interface 349, via the user interface 329, etc.) the overage passcode 308C (e.g., “3457”) associated with the account, as represented by block 130; and (e) authorize the transaction based at least partially on receiving the overage passcode 308C, as represented by block 140. In accordance with some embodiments, the transaction machine 320, the authorization apparatus 330, and/or the mobile device 340 are each configured to send and/or receive one or more instructions to and/or from each other, such that an instruction sent, for example, from the authorization apparatus 330 to the mobile device 340 (and/or vice versa) can trigger the mobile device 340 (and/or vice versa) to perform one or more portions of any one or more of the embodiments described and/or contemplated herein.

Referring now to FIG. 4, a mixed block and flow diagram of a system 400 for providing an overdraft service using an overdraft PIN and a mobile phone is provided, in accordance with an exemplary embodiment of the present invention. It will be understood that the system 400 illustrated in FIG. 4 represents an example embodiment of the process flow 200 described in connection with FIG. 2. As shown, the system 400 includes a POS device 401 (e.g., the transaction machine 320, a merchant terminal, etc.), an authorization server 403 (e.g., the authorization apparatus 330, etc.), and a mobile phone 405 (e.g., the mobile device 340, etc.). The POS device 401, the authorization server 403, and the mobile phone 405 may each include a communication interface, a user interface, a processor, a memory, an application, and/or a datastore, and those components may be operatively connected to each other.

In accordance with some embodiments, the POS device 401 and the mobile phone 405 are operatively and selectively connected to the authorization server 403 via one or more networks (not shown). For example, in some embodiments, the POS device 401 is operatively connected to the authorization server 403 via a payment network, and/or the mobile phone 405 is operatively connected to the authorization server 403 via a telephone network. Also, the POS device 401 and the mobile phone 405 are accessible to a customer of a financial institution (not shown). Also, in this example embodiment, the POS device 401 is maintained by a merchant, the mobile phone 405 is maintained by the customer of the financial institution, and the authorization server 403 is maintained by the financial institution. Further, in accordance with some embodiments, the financial institution maintains the checking account held by the customer and associated with the debit card mentioned below. Still further, in this example embodiment, the checking account is associated with a primary PIN and an overdraft PIN. In some embodiments, these PINs were selected by or assigned to the customer before the transaction referred to in FIG. 4 was initiated (e.g., before the customer performs the function represented by block 402).

As represented by block 402, the customer swipes a debit card at the POS device 401 and inputs the primary PIN into the POS device 401 to engage in a debit card transaction involving the customer and the merchant. Although not shown, the POS device 401 may also authenticate the customer based at least partially on one or more credentials the customer provides to the POS device 401 (e.g., based on the debit card swiped, the primary PIN provided, etc.). Next, as represented by block 404, the POS device 401 generates and sends an authorization request associated with the debit card transaction to the authorization server 403. In accordance with some embodiments, the authorization request includes information that, for example, identifies the customer, the primary PIN, the checking account associated with the debit card, the amount of the transaction, the one or more goods and/or services involved in the transaction, and/or the like. As represented by block 406, the authorization server 403 then determines that the checking account associated with the debit card will incur an overdraft as a result of the transaction. In this example embodiment, after making the overdraft determination, the authorization server 403 declines the authorization request, as represented by block 408. Also, as represented by block 410, the authorization server 403 determines that the customer is enrolled in an overdraft service provided by the financial institution. Thereafter, as represented by block 412, the authorization server 403 identifies a phone number associated with the checking account by, for example, accessing an account datastore and/or account profile having information associated with the checking account (e.g., the phone number) stored therein. In some embodiments, the customer provides the financial institution with his phone number (e.g., the phone number of the mobile phone 405) when the customer enrolls in the overdraft service.

After the authorization server 403 identifies the phone number, the authorization server 403 sends a text message (e.g., SMS message, MMS message, EMS message, etc.) to the phone number, which corresponds to the mobile phone 405, as represented by block 414. In accordance with some embodiments, the text message received by the mobile phone 405: (a) notifies the customer of the overdraft; and (b) prompts the customer to consent to the overdraft by: (i) re-swiping the debit card at the POS device 401; and (ii) inputting the overdraft PIN into the POS device 401. In some embodiments, the text message received by the mobile phone 405 is delivered visually to the customer via a display of the mobile phone 405. After reading the text message at the mobile phone 414, the customer re-swipes the debit card at the POS device 401 and inputs the overdraft PIN into the POS device 401, as represented by block 416. In some embodiments, by re-swiping the debit card and/or inputting the overdraft PIN, the customer agrees to overdraft the checking account in order to complete the overdraft transaction, agrees to complete the transaction, and/or agrees to incur one or more overdraft fees associated with using the overdraft service and/or overdrafting the checking account.

After the customer re-swipes the debit card and inputs the overdraft PIN, the POS device 401 generates and sends another authorization request to the authorization server 403, as represented by block 418, which is approved by the authorization server 403, as represented by block 420. In some embodiments, the authorization server 403 approves the second authorization request based at least partially on receiving the customer's overdraft PIN and/or based at least partially on the customer re-swiping his debit card at the POS device 401. After the second authorization request has been approved, the transaction is completed at the POS device 401, as represented by block 422. It will be understood that, in some embodiments, the first authorization request, as represented by block 404, represents the first attempt to complete the transaction referred to in block 402, and the second authorization request, as represented by block 418, represents a second attempt to complete the same transaction. In addition to completing the transaction, in some embodiments, as represented by block 424, the authorization server 403 is configured to generate and/or send an email to the mobile phone 405 that confirms that the customer consented to the overdraft by inputting the overdraft PIN into the POS device 401.

Of course, the embodiment illustrated in FIG. 4 is merely exemplary and other embodiments may vary without departing from the scope and spirit of the present invention. For example, in some alternative embodiments, the first authorization request is not declined by the authorization server 403, the customer is not required to re-swipe the debit card at the POS device 401, and the second authorization request is never sent. Instead, in such embodiments, after receiving the customer's consent to the overdraft, the authorization server 403 is configured to approve the first authorization request referred to in block 404, and the transaction is completed at the POS device 401. As another example, in some alternative embodiments, one or more portions of the process flow being performed by the mobile phone 405 are performed instead by the POS device 401. As still another example, in some alternative embodiments of the present invention, instead of involving a debit card, a checking account, a debit card transaction, and/or an overdraft service, the process flow shown in FIG. 4 involves a credit card, a credit card account, a credit card transaction, and/or an over limit service. As still another example, in some alternative embodiments, the customer does not need to re-swipe the debit card at the POS device 401 to complete the overdraft transaction; instead, the customer need only input the overdraft PIN at the POS device 401.

As yet another example, in some alternative embodiments, the customer is not prompted via the mobile phone 405 to input the overdraft PIN into the POS device 401; rather, in such embodiments, the customer is prompted to input the overdraft PIN into the POS device 401 based at least partially on the transaction being declined (e.g., the transaction being declined is what prompts the customer to input the overdraft PIN). As another example, in some alternative embodiments, the customer is prompted (e.g., via the mobile phone 405, via the POS device 401, etc.) to input the overage PIN into the mobile phone 405 (e.g., into an input field of a mobile banking application executing on the mobile phone 405) instead of inputting the overdraft PIN into the POS device 401. As another example, in some alternative embodiments, the customer receives the overdraft PIN in the text message referred to in block 414. In some of these embodiments, the customer does not know the identity of the overdraft PIN before the text message is sent (e.g., the server 403 dynamically generates the overdraft PIN after determining that the checking account will incur the overdraft).

In some embodiments, one or more of the portions of the process flow represented by blocks 402-424 are triggered by one or more triggering events, which, in some embodiments, include the performance of one or more of the other portions of the process flow represented by blocks 402-424. Also, in some embodiments, the system 400 is configured to perform the entire process flow represented by blocks 402-424, from start to finish, within moments, seconds, and/or minutes. For example, in some embodiments, the customer inputs the overdraft PIN into the POS device 401 within approximately 1-5 minutes of the authorization server 403 receiving the authorization request from the POS device 401. Further, it will be understood that one or more portions of the process flow represented by blocks 402-424 are configured to comply with one or more requirements of an overage regulation (e.g., Regulation E and/or the CARD Act in the United States).

Referring now to FIG. 5, a mixed block and flow diagram of a system 500 for providing an over limit service using an over limit password and a mobile phone having an NFC interface is provided, in accordance with an exemplary embodiment of the present invention. It will be understood that the system 500 illustrated in FIG. 5 represents an example embodiment of the process flow 100 described in connection with FIG. 1. As shown, the system 500 includes a POS device 501 having an NFC interface, a mobile phone 503 having an NFC interface, and an authorization server 505. The POS device 501, the mobile phone 503, and the authorization server 505 may each include a communication interface, a user interface, a processor, a memory, an application, and/or a datastore, and those components may be operatively connected to each other.

In accordance with some embodiments, the POS device 501 and the mobile phone 503 are operatively and selectively connected to the authorization server 505 via one or more networks (not shown). For example, in some embodiments, the POS device 501 is operatively connected to the authorization server 505 via a payment network, and/or the mobile phone 503 is operatively connected to the authorization server 505 via a telephone network. In addition, the NFC interface of the mobile phone 503 and the NFC interface of the POS device 501 enable the mobile phone 503 to wirelessly and/or contactlessly communicate with the POS device 501. For example, in some embodiments, the mobile phone 503 includes an RF transmitter that is configured to wirelessly and/or contactlessly communicate account and/or transaction information to and/or from an NFC reader associated with the POS device 501. As such, in accordance with some embodiments, the mobile phone 503 is configured to operate as a mobile wallet.

It will be understood that the POS device 501 and the mobile phone 503 are accessible to the customer referred to in block 502. Also, in this example embodiment, the POS device 501 is maintained by a merchant, the mobile phone 503 is maintained by the customer, and the authorization server 505 is maintained by a bank. Further, in accordance with some embodiments, the bank maintains the credit card account held by the customer, and the mobile phone is associated with the credit card account.

As represented by block 502, the customer logs in to a mobile banking application that is installed and/or executes on the mobile phone 503. In some embodiments, the mobile banking application authenticates the customer before providing the customer access to the mobile banking application. In some embodiments, the mobile banking application authenticates the customer based at least partially on one or more credentials provided by the customer to the application (e.g., a primary password associated with the credit card account).

After logging in, the customer presents the mobile phone 503 to the POS device 501 to engage in the transaction, as represented by block 504. For example, in some embodiments, the customer “taps” the mobile phone 503 to the POS device 501 by holding the NFC interface of the mobile phone 503 within a relatively short range of (e.g., within approximately four inches of, etc.) the NFC interface of the POS device 501. When the mobile phone 503 is presented to the POS device 501, the POS device 501 receives credit card account information from the mobile phone 503, as represented by block 506. In some embodiments, the credit card account information includes the credit card account number, the primary password associated with the account, the name of the customer, and/or the like. Thereafter, the POS device 501 generates and sends an authorization request associated with the transaction to the authorization server 505, as represented by block 508. In accordance with some embodiments, the authorization request includes information that, for example, identifies the customer, the credit card account associated with the mobile phone, the primary password associated with the account, the amount of the transaction, the one or more goods and/or services involved in the transaction, and/or the like. After receiving the authorization request, as represented by block 510, the authorization server 505 determines that the credit card account involved in the transaction will go over limit as a result of the transaction. After making the over limit determination, the authorization server 505, in this example embodiment, determines that the customer is enrolled in an over limit service provided by the bank, as represented by block 512. Thereafter, as represented by block 514, the authorization server 505 identifies a mobile phone associated with the credit card account (e.g., the mobile phone 503). In some embodiments, the server 505 identifies the mobile phone by identifying a phone number associated with the account, which in some embodiments, is stored in an account profile associated with the account. For example, in some embodiments, the customer provides the financial institution with his phone number (e.g., the phone number of the mobile phone 503) when the customer enrolls in the over limit service.

After the authorization server 505 identifies the mobile phone, the authorization server 505 sends a communication (e.g., text message, automated phone call, mobile banking application-specific notification, actionable alert, email, social media-specific message, etc.) to the mobile phone 503, as represented by block 516. In accordance with some embodiments, the communication notifies the customer of the over limit amount and/or prompts the customer to consent to going over limit by inputting the over limit password associated with the account into the mobile phone 503. In some embodiments, the communication received by the mobile phone 503 is delivered visually to the customer via a display of the mobile phone 503 and/or audibly via a speaker of the mobile phone 503. After perceiving the communication at the mobile phone 503, the customer consents to going over limit by inputting the over limit password into the mobile phone 503, as represented by block 518. For example, in some embodiments, the customer uses a keypad to input the over limit password (e.g., “3450”) into a mobile banking application-specific input field displayed on the mobile phone 503. As another example, in some embodiments, the customer sends a return text message to the server 505, where the return text message includes the over limit password. In some embodiments, by inputting the over limit password into the mobile phone 503, the customer agrees to the over limit amount, agrees to exceeding the credit limit of the credit card account, agrees to complete the over limit transaction, and/or agrees to incurring an over limit fee for using the over limit service and/or for going over limit.

After the customer inputs the over limit password, the authorization server 505 approves the authorization request, as represented by block 520. As represented by block 522, the authorization server 505 also generates and sends an electronic receipt associated with the credit card transaction to the mobile banking account. In some embodiments, this electronic receipt serves as a confirmation message to confirm that the customer inputted the over limit password into the mobile phone 503 and/or to confirm the customer's consent to going over limit and/or to completing the transaction. After the authorization request has been approved, the transaction is completed at the POS device 501, as represented by block 524.

Of course, the embodiment illustrated in FIG. 5 is merely exemplary and other embodiments may vary without departing from the scope and spirit of the present invention. For example, in some embodiments, one or more portions of the process flow being performed by the authorization server 505 are performed instead by the mobile phone 503. As another example, in some alternative embodiments of the present invention, instead of involving a credit card account and/or an over limit service, the system 500 shown in FIG. 5 involves a deposit account, overdraft, and/or an overdraft service.

Also, in some embodiments, one or more of the portions of the process flow represented by blocks 502-524 are triggered by one or more triggering events, which, in some embodiments, include the performance of one or more of the other portions of the process flow represented by blocks 502-524. Also, in some embodiments, the system 500 is configured to perform the entire process flow represented by blocks 502-524, from start to finish, within moments, seconds, and/or minutes. For example, in some embodiments, the customer inputs the over limit password (and/or consents to going over limit) within approximately 1-5 minutes of the authorization server 505 receiving the authorization request from the POS device 501. Further, it will be understood that one or more portions of the process flow represented by blocks 502-524 are configured to comply with one or more requirements of an overage regulation (e.g., Regulation E and/or the CARD Act in the United States, etc.).

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving transaction information associated with a transaction, wherein the transaction involves an account;
determining, based at least partially on the transaction information, that the account will incur an overage as a result of the transaction;
receiving an overage passcode associated with the account; and
authorizing the transaction based at least partially on the receiving the overage passcode.

2. The method of claim 1, wherein the transaction information comprises the overage passcode, such that the receiving the transaction information comprises the receiving the overage passcode.

3. The method of claim 1, wherein the transaction information comprises a primary passcode associated with the account, and wherein the receiving the overage passcode occurs after the receiving the transaction information.

4. The method of claim 1, wherein the transaction involves a holder of the account, the method further comprising:
prompting the holder to provide the overage passcode, wherein the prompting the holder occurs after the determining that the account will incur the overage, and
wherein the receiving the overage passcode occurs after the prompting the holder.

5. The method of claim 4, wherein the prompting the holder occurs within about twenty seconds of the determining that the account will incur the overage.

6. The method of claim 4, wherein the prompting the holder comprises sending a message to a mobile device accessible to the holder, wherein the message prompts the holder to provide the overage passcode.

7. The method of claim 4, wherein the transaction involves a transaction machine, and wherein the prompting the holder comprises sending a message to the transaction machine, wherein the message prompts the holder to provide the overage passcode.

8. The method of claim 4, wherein the prompting the holder comprises sending the amount of the overage to the holder.

9. The method of claim 4, wherein the prompting the holder comprises sending the overage passcode to the holder.

10. The method of claim 9, wherein the overage passcode is not known to the holder before the sending the overage passcode to the holder.

11. The method of claim 4, wherein the overage passcode is known to the holder before the prompting the holder.

12. The method of claim 1, wherein the transaction involves a holder of the account, the method further comprising:
declining the transaction based at least partially on the determining that the account will incur an overage, and
wherein the receiving the overage passcode comprises receiving the overage passcode from the holder after the declining the transaction.

13. The method of claim 1, wherein the transaction involves a holder of the account and a transaction machine, and wherein the receiving the overage passcode is based at least partially on the holder inputting the overage passcode into the transaction machine.

14. The method of claim 1, wherein the transaction involves a holder of the account, and wherein the receiving the overage passcode is based at least partially on the holder inputting the overage passcode into a mobile device accessible to the holder.

15. The method of claim 1, further comprising:
receiving second transaction information associated with a second transaction, wherein the second transaction involves a second account, and wherein the second account is associated with a primary passcode;
determining, based at least partially on the second transaction information, that the second account will incur an overage as a result of the second transaction;
receiving the primary passcode; and
declining the second transaction based at least partially on the receiving the primary passcode.

16. The method of claim 1, wherein the transaction involves a holder of the account, and wherein the overage passcode was selected by the holder before the transaction is initiated.

17. The method of claim 1, wherein the transaction involves a holder of the account, and wherein the receiving the overage passcode serves to indicate that the holder consents to the overage.

18. The method of claim 1, further comprising:
storing the overage passcode in an account profile associated with the account, wherein the account profile is stored in a computer-readable medium; and
after receiving the overage passcode, determining that the overage passcode received matches the overage passcode stored in the account profile, and
wherein the authorizing the transaction is based at least partially on the determining that the overage passcode received matches the overage passcode stored in the account profile.

19. The method of claim 1, wherein the passcode is a four digit personal identification number (PIN).

20. An apparatus comprising:
a communication interface configured to:
receive, via a payment network, transaction information associated with a transaction, wherein the transaction involves an account; and
receive an overage passcode associated with the account;
a processor operatively connected to the communication interface and configured to:
determine, based at least partially on the transaction information, that the account will incur an overage as a result of the transaction; and
authorize the transaction based at least partially on the communication interface receiving the overage passcode.

21. The apparatus of claim 20, wherein the communication interface is configured to receive the overage passcode via a telephone network.

22. The apparatus of claim 20, wherein the transaction information comprises the overage passcode, such that the communication interface receives the overage passcode by receiving the transaction information.

23. The apparatus of claim 20, wherein the transaction information comprises a primary passcode associated with the account, and wherein the communication interface receives the overage passcode after receiving the transaction information.

24. The apparatus of claim 20, wherein the processor is further configured to:
instruct the communication interface to prompt the holder to provide the overage passcode, wherein the processor instructs the communication interface to prompt the holder after the processor determines that the account will incur the overage, and
wherein the communication interface receives the overage passcode after the processor instructs the communication interface to prompt the holder.

25. The apparatus of claim 24, wherein the processor instructs the communication interface to prompt the holder by instructing the communication interface to send a message to a mobile device accessible to the holder, wherein the message prompts the holder to provide the overage passcode.

26. The apparatus of claim 24, wherein the transaction involves a transaction machine, and wherein the processor instructs the communication interface to prompt the holder by instructing the communication interface to send a message to the transaction machine, wherein the message prompts the holder to provide the overage passcode.

27. The apparatus of claim 24, wherein the processor instructs the communication interface to prompt the holder by instructing the communication interface to send the overage passcode to the holder.

28. The apparatus of claim 27, wherein the overage passcode is not known to the holder before the overage passcode is sent to the holder.

29. The apparatus of claim 20, wherein the transaction involves a holder of the account, and wherein the processor is further configured to:
decline the transaction based at least partially on the processor determining that the account will incur an overage, and
wherein the communication interface receives the overage passcode from the holder after the transaction is declined.

30. The apparatus of claim 20, wherein the transaction involves a holder of the account and a transaction machine, and wherein the communication interface receives the overage passcode based at least partially on the holder inputting the overage passcode into the transaction machine.

31. The apparatus of claim 20, wherein the transaction involves a holder of the account, and wherein the communication interface receives the overage passcode based at least partially on the holder inputting the overage passcode into a mobile device accessible to the holder.

32. The apparatus of claim 20,
wherein the communication interface is further configured to:
receive second transaction information associated with a second transaction, wherein the second transaction involves a second account, and wherein the second transaction information comprises a primary passcode that is associated with the second account, and
wherein the processor is further configured to:
determine, based at least partially on the second transaction information, that the second account will incur an overage as a result of the second transaction; and
decline the second transaction based at least partially on the communication interface receiving the primary passcode.

33. The apparatus of claim 20, further comprising:
a memory device operatively connected to the processor and configured to store the overage passcode,
wherein the processor is further configured to determine, after the communication interface receives the overage passcode, that the overage passcode received matches the overage passcode stored in the memory device, and
wherein the processor authorizes the transaction based at least partially on the processor determining that the overage passcode received matches the overage passcode stored in the memory device.

34. A computer program product comprising a non-transitory computer-readable medium, wherein the non-transitory computer-readable medium comprises one or more computer-executable program code portions that, when executed by a computer, cause the computer to:
receive transaction information associated with a transaction, wherein the transaction involves an account;
determine that the account will incur an overage as a result of the transaction;
receive an overage passcode associated with the account after the computer determines that account will incur an overage; and
authorize the transaction based at least partially on the computer receiving the overage passcode.

35. The computer program product of claim 34, wherein the transaction involves a transaction machine, and wherein the one or more computer-executable program code portions, when executed by the computer, cause the computer to:
send a message to the transaction machine, wherein the message prompts the holder to input the overage passcode into the transaction machine,
wherein the computer sends the message after the computer determines that the account will incur the overage, and
wherein the computer receives the overage passcode after the computer sends the message, and wherein the computer receives the overage passcode based at least partially on the holder inputting the overage passcode into the transaction machine.

36. The computer program product of claim 34, wherein the transaction involves a transaction machine and a holder of the account, wherein the holder carries a mobile device during the transaction, and wherein the one or more computer-executable program code portions, when executed by the computer, cause the computer to:
send a message to the mobile device, wherein the message prompts the holder to input the overage passcode into the mobile device or into the transaction machine, and
wherein the computer sends the message after the computer determines that the account will incur the overage, and
wherein the computer receives the overage passcode after the computer sends the message, and wherein the computer receives the overage passcode based at least partially on the holder inputting the overage passcode into the mobile device or the transaction machine.

37. The computer program product of claim 34, wherein the transaction involves a transaction machine, and wherein the one or more computer-executable program code portions, when executed by the computer, cause the computer to:
send the overage passcode to the holder before the computer receives the overage passcode, wherein the overage passcode is not known to the holder before the overage passcode is sent to the holder.

38. The computer program product of claim 34, wherein the one or more computer-executable program code portions, when executed by the computer, cause the computer to:
decline the transaction based at least partially on the computer determining that the account will incur an overage, and
wherein the computer receives the overage passcode after the transaction is declined.

39. The computer program product of claim 34, wherein the transaction involves a holder of the account, and wherein the overage passcode was selected by the holder before the transaction is initiated.

40. A method comprising:
receiving an authorization request associated with a transaction, wherein the transaction involves an account, and wherein the account is associated with a primary passcode;
determining that the account does not have sufficient funds or credit to cover the transaction;
determining that the authorization request comprises the primary passcode;
declining the authorization request based at least partially on the determining that the authorization request comprises the primary passcode and the determining that the account does not have sufficient funds or credit;
receiving a second authorization request associated with a second transaction, wherein the second transaction involves the account;
determining that the second authorization request comprises an overage passcode associated with the account; and
approving the second authorization request based at least partially on the determining that the second authorization request comprises the overage passcode.

41. The method of claim 40, wherein the transaction and the second transaction are the same transaction.

42. The method of claim 40, wherein the receiving the second authorization request comprises receiving the second authorization request within about five minutes of the declining the authorization request.

43. The method of claim 40, wherein the transaction involves a holder of the account, the method further comprising:
prompting the holder to provide the overage passcode, wherein the prompting the holder occurs after the determining that the account does not have sufficient funds, and
wherein the receiving the second authorization request comprises receiving the overage passcode from the holder after the prompting the holder to provide the overage passcode.

44. A method comprising:
presenting, by a holder of an account, account information at a transaction machine to engage in a transaction, wherein the account information is associated with the account;
receiving, by the holder, a message that prompts the holder to provide an overage passcode associated with the account, wherein the receiving occurs while the holder is still at the transaction machine; and
inputting, by the holder, the overage passcode into the transaction machine or into a mobile device accessible to a holder, wherein the inputting occurs while the holder is still at the transaction machine, and wherein the transaction is approved after the holder inputs the overage passcode.

45. The method of claim 44, wherein the message further prompts the holder to re-present the account information at the transaction machine to complete the transaction, the method further comprising:
re-presenting, by the holder, the account information at the transaction machine.

46. The method of claim 44, wherein the message notifies the holder that the transaction has been declined.

47. The method of claim 44, further comprising:
receiving, by the holder, a confirmation message that confirms that the holder input the overage passcode into the transaction machine or into the mobile device.

48. The method of claim 44, further comprising:
receiving, by the holder, disclosure information before the presenting the account information at the transaction machine, wherein the disclosure information defines one or more terms of an overage service associated with the overage passcode, and
wherein the inputting the overage passcode comprises agreeing, by the holder, to the one or more terms of the overage service defined in the disclosure information.
